(19) United States
(12) Patent Application Publication
(10) Pub. No.: US 2026/0138278 A1
(43) Pub. Date: May 21, 2026

(54) AUTONOMOUS WHEEL-TIRE MANAGEMENT SYSTEM

(71) Applicant: PitPro Automation, Inc., San Francisco, CA (US)

(72) Inventors: Guilherme Cavalcanti, Martinez, CA (US); Miles Pekala, San Francisco, CA (US); Boone Adkins, San Francisco, CA (US); Jeremy Conrad, San Francisco, CA (US)

(21) Appl. No.: 19/394,227

(22) Filed: Nov. 19, 2025

Related U.S. Application Data
(60) Provisional application No. 63/722,271, filed on Nov. 19, 2024.
(60) Provisional application No. 63/794,015, filed on Apr. 24, 2025.
(60) Provisional application No. 63/896,606, filed on Oct. 9, 2025.

(51) Int. Cl. B25J 9/16; B25J 11/00; B25J 19/02; B60C 25/05

(52) U.S. Cl. CPC B25J 9/1687; B25J 11/005; B25J 19/021; B60C 25/0515

(57) ABSTRACT

One variation of a system includes a tire interface assembly including: an enclosure defining a driver window; a set of end effectors configured to retain a wheel assembly mounted to a vehicle adjacent the enclosure; an internal optical sensor arranged within the enclosure; an external optical sensor arranged on the enclosure; and a driver arranged within the enclosure and configured to maneuver across the driver window to engage a lug fastener of the wheel assembly, remove the lug fastener from the wheel assembly, and store the lug fastener at a lug holder within the enclosure. This variation of the system also includes a set of actuators configured to maneuver the tire interface assembly to: locate the driver window substantially parallel and concentric with the wheel assembly; and locate the driver substantially orthogonal to the wheel assembly.

### CROSS-REFERENCE TO RELATED APPLICATIONS

This Application claims the benefit of U.S. Provisional Application No. 63/896,606, filed on 9 Oct. 2025, U.S. Provisional Application No. 63/794,015, filed on 24 Apr. 2025, and U.S. Provisional Application No. 63/722,271, filed on 19 Nov. 2024, each of which is incorporated in its entirety by this reference.

### TECHNICAL FIELD

This invention relates generally to the field of wheel-tire management and, more specifically, to a new and useful system for autonomously replacing and/or rotating multiple wheel assemblies of a vehicle in the field of wheel-tire management.

### BRIEF DESCRIPTION OF THE FIGURES

FIGS. 1A-1C are flowchart representations of a method;

FIGS. 2A and 2B are flowchart representations of one variation of the method;

FIG. 3 is a flowchart representation of one variation of the method;

FIG. 4 is a flowchart representation of one variation of the method;

FIGS. 5A and 5B are schematic representations of a system;

FIGS. 6A and 6B are schematic representations of one variation of the system;

FIGS. 7A and 7B are schematic representations of one variation of the system;

FIG. 8 is a schematic representation of one variation of the system; and

FIGS. 9A and 9B are schematic representations of one variation of the system.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. System

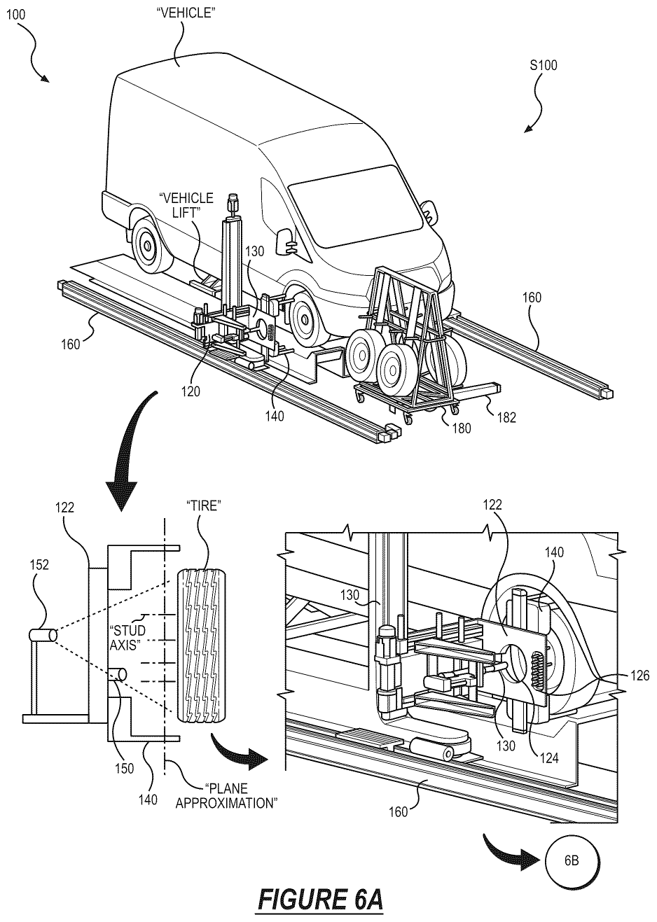

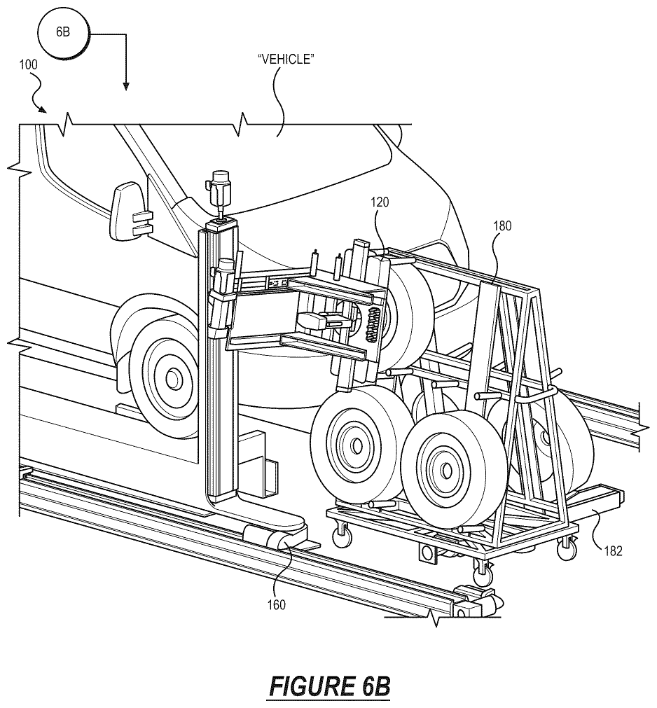

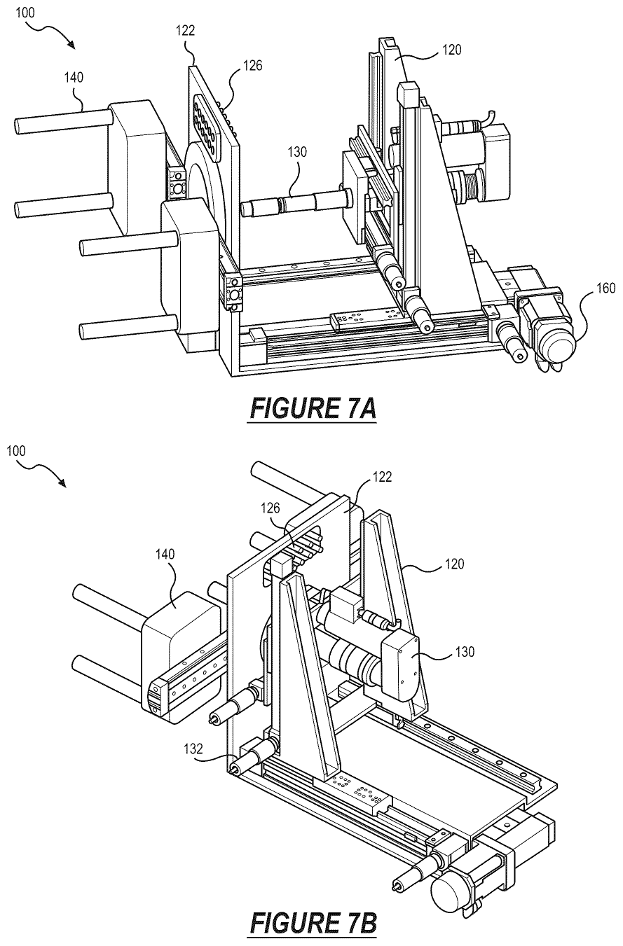

As shown in FIGS. 6A, 6B, 7A, 7B, and 8, a system 100 configured to install (or transiently locate) proximal a vehicle lift includes: a tire interface assembly 120; a set of actuators 160; a tire cart 180; and a tire cart 180 receptacle.

The tire interface assembly 120 includes: an enclosure 122 defining a driver window 124 (e.g., an aperture); a lug holder 126 arranged within the enclosure 122 and configured to store lug fasteners; a set of end effectors 140 (e.g., a parallel-jaw gripper) supported on the enclosure 122 about (e.g., concentric with) the driver window 124 and configured to transiently retain a wheel-tire assembly (hereinafter “wheel assembly”); an end effector actuator configured to rotate the set of end effectors 140 (concentrically) about the driver window 124; an internal optical sensor 152 (e.g., a depth sensor 156, a stereoscopic color camera) arranged within the enclosure 122 and defining a field of view intersecting (and concentric with) the driver window 124; an external optical sensor 150 (e.g., a depth sensor 156, a stereoscopic color camera) arranged proximal the driver window 124 and defining a field of view external to the enclosure 122; a driver 130 (e.g., an impact driver 130) configured to apply a torque (e.g., breakaway torque, tightening torque) to a lug fastener; and a multi-axis driver actuator 132 (e.g., set of three orthogonal linear actuators) configured to maneuver the driver 130 across the driver window 124 to engage a circular pattern of lug fasteners of a wheel hub of a vehicle (e.g., a cargo vehicle) adjacent the tire interface assembly 120 and to maneuver the driver 130 between the driver window 124 and the lug holder 126 within the enclosure 122.

The set of actuators 160 is configured to locate on a first side of the vehicle lift and includes: a set of linear actuators (e.g., longitudinal, lateral, vertical linear actuators) configured to maneuver the tire interface assembly 120 along the vehicle lift and to align the driver window 124 to the wheel hub of the vehicle when located on the vehicle lift; and a set of rotary actuators (e.g., pitch actuators, yaw actuators) configured to align an axis of the driver window 124 coaxial the wheel hub of the vehicle (or normal to a plane normal to the wheel-tire assembly installed on the wheel hub of the vehicle).

The tire cart 180 includes: a base (e.g., rectilinear base); a set of wheels (e.g., casters, rollers) arranged at corners of the base; a storage rack; and a latch. The storage rack: includes a first set of slots (or wheel assembly cubbies, receivers, receptacles, retainers) arranged on a first side of the storage rack and configured to support a first set of wheel assemblies; includes a second set of slots arranged on a second side of the storage rack, opposite the first side, and configured to support a second set of wheel assemblies; and is arranged above and pivotably coupled to the base. The latch is configured to selectively retain an angular position of the storage rack on the base and to release the storage rack to rotate on the base.

The tire cart 180 receptacle: is configured to locate adjacent the set of actuators 160; is configured to receive and retain the tire cart 180; and includes a set of cart actuators 182 configured to release the latch of the tire cart 180 and to rotate the storage rack on the base of the tire cart 180 to selectively expose the first set of slots and the second set of slots of the tire cart 180 to the tire interface assembly 120.

### 1.1 Second Tire Interface Assembly

In one variation, the system 100 includes: a first instance of the tire interface assembly 120 and the set of actuators 160 arranged on a first side of the vehicle lift; a second instance of the tire interface assembly 120 and the set of actuators 160 arranged on a second side, opposite the first side, of the vehicle lift; and the wheel assembly receptacle interposed between the first instance and the second instance of the tire interface assembly 120 and the set of actuators 160.

### 1.2 Controls: Tire Interface Assembly Orientation+Wheel Assembly Retention

The system 100 further includes a controller configured to: trigger the set of linear actuators to maneuver the tire interface assembly 120 proximal a first wheel assembly arranged on a first side of the vehicle; access a first image captured by the external optical sensor 150 and depicting the first wheel assembly; generate a first plane approximation of a first wheel disc of the first wheel assembly based on the first image; and, based on the first plane approximation, derive a first target pose for the tire interface assembly 120 that locates the driver window 124 substantially parallel the first wheel disc of the first wheel assembly and that locates the driver 130 substantially orthogonal to the first wheel disc of the first wheel assembly.

The controller is also configured to: trigger the set of rotary actuators to orient the tire interface assembly 120 according to the first target pose; and trigger the set of end effectors 140 to transiently retain the first wheel assembly.

### 1.3 Controls: Lug Fastener Loosening+Storage

The controller is further configured to: access a loosening pattern (e.g., star pattern) associated with the first wheel assembly; access a second image captured by the internal optical sensor 152 and depicting the first wheel disc of the first wheel assembly; detect a first lug fastener in a first region of the first image; identify a first position, corresponding to the first region, of the first lug fastener on the first wheel disc; trigger the multi-axis driver actuator 132 of the tire interface assembly 120 to maneuver the driver 130 to the first position; and trigger the driver 130 to apply a breakaway torque to the first lug fastener that loosens the first lug fastener from a corresponding lug stud of a wheel hub.

The controller can then repeat the steps described above to trigger the driver 130 to apply the breakaway torque across a set of lug fasteners on the first wheel disc according to the loosening pattern.

The controller is further configured to: trigger the multi-axis driver actuator 132 of the tire interface assembly 120 to maneuver the first lug fastener, via the driver 130, proximal the lug holder 126 on the enclosure 122; and trigger the lug holder 126 to transiently retain the lug fastener.

### 1.4 Controls: Wheel Assembly Stowing+Cart Rotation

The controller is further configured to: trigger the set of linear actuators to maneuver the first wheel assembly, via the set of end effectors 140, proximal the first set of slots on the first side of the storage rack; trigger the set of end effectors 140 to release the first wheel assembly onto the first set of slots on the first side of the storage rack; and trigger the set of cart actuators 182 to rotate the tire cart 180 to locate the second set of slots, pre-loaded with a second wheel assembly, on the second side of the storage rack proximal the tire interface assembly 120.

### 1.5 Controls: Wheel Assembly Retrieval+Tire Interface Assembly Orientation

The controller is also configured to: access a third image captured by the external optical sensor 150 and depicting the second wheel assembly at the second set of slots on the second side of the storage rack; generate a second plane approximation of a second wheel disc of the second wheel assembly based on the second image; and, based on the second plane approximation, derive a second target pose for the tire interface assembly 120 that locates the driver window 124 substantially parallel with the second wheel disc of the second wheel assembly and that locates the driver 130 substantially orthogonal to the second wheel disc of the second wheel assembly.

The controller is further configured to: trigger the set of rotary actuators to orient the tire interface assembly 120 according to the second target pose; and trigger the set of end effectors 140 to transiently retain the second wheel assembly from the tire cart 180.

### 1.6 Controls: Wheel Assembly Positioning+Stud and Aperture Alignment

The controller is also configured to: trigger the set of linear actuators to maneuver the second wheel assembly, via the set of end effectors 140, proximal a wheel hub of the vehicle; access a fourth image captured by the external optical sensor 150 and depicting the wheel hub; and detect a set of threaded lug studs arranged on the wheel hub in the fourth image.

The controller is further configured to, based on the fourth image: derive a stud axis, in a set of stud axes, for each lug stud in the set of threaded lug studs; calculate an average stud axis based on the set of stud axes; and derive a stud plane approximation orthogonal to the set of threaded lug studs.

The controller is also configured to derive a third target pose of the tire interface assembly 120 that: locates the driver window 124 of the enclosure 122 substantially parallel to the stud plane approximation; locates a driver axis of the driver 130 coaxial with the average stud axis; and locates a set of lug stud apertures on the second wheel disc in alignment with the set of threaded lug studs.

The controller is further configured to: trigger the set of actuators 160 to locate the tire interface assembly 120 at the third target pose; and trigger the left set of actuators 160 to maneuver the second wheel assembly, via the set of end effectors 140, toward the wheel hub of the vehicle.

### 1.7 Controls: Lug Fastener Pre-Fastening

The controller is also configured to: access a fastening pattern (e.g., star pattern) associated with the second wheel assembly; access a sixth image captured by the internal optical sensor 152 and depicting the second wheel disc of the second wheel assembly; detect a first threaded lug stud in a second region within the sixth image; identify a second position, corresponding to the second region, of the first threaded lug stud on the second wheel disc; trigger the multi-axis driver actuator 132 of the tire interface assembly 120 to maneuver the driver 130 proximal the lug holder 126 on the enclosure 122; the lug holder 126 to release the lug fastener; trigger the multi-axis driver actuator 132 of the tire interface assembly 120 to maneuver the driver 130 toward the second position of the first threaded lug stud; and trigger the driver 130 the apply a pre-fastening torque to snug the first lug fastener at the threaded lug stud.

The controller can then repeat the steps described above to trigger the driver 130 to apply the pre-fastening torque across a set of lug fasteners on a set of threaded lug studs according to the fastening pattern.

### 1.8 Torque Tightening Specification

The controller is further configured to, following the application of the pre-fastening torque across the set of lug fasteners: access a torque threshold associated with the second wheel assembly; access a set of torque values from a moment sensor coupled to the driver 130; trigger the driver 130 to apply a tightening torque to the first lug fastener at the first threaded lug stud; and, in response to the set of torque values exceeding the torque threshold, trigger the driver 130 to terminate application of the tightening torque to the first lug fastener.

The controller can then repeat the steps described above to trigger the driver 130 to apply the tightening torque across a set of lug fasteners on a set of threaded lug studs according to the fastening pattern.

### 1.9 Variation: Integrated Enclosure Assembly

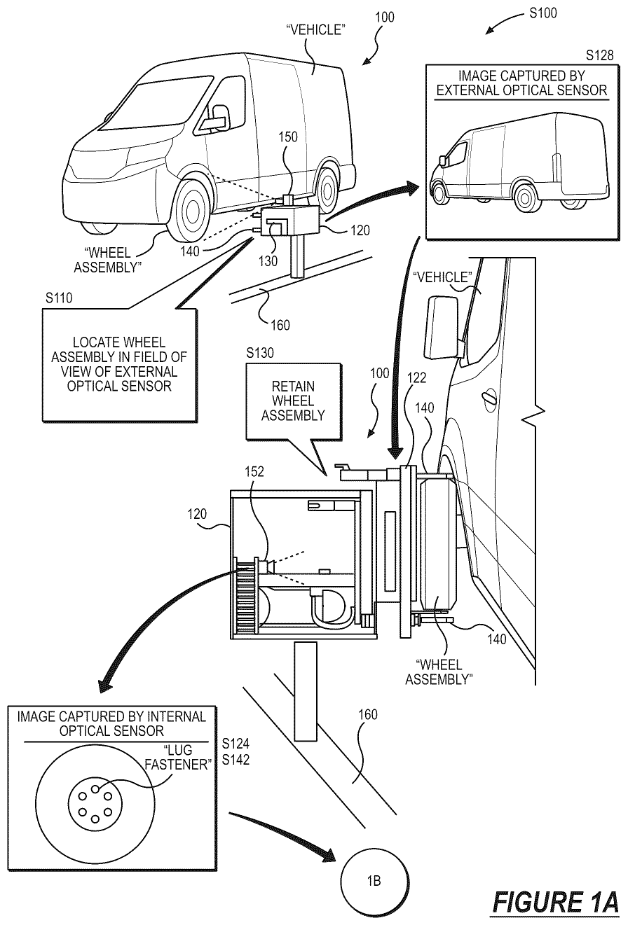

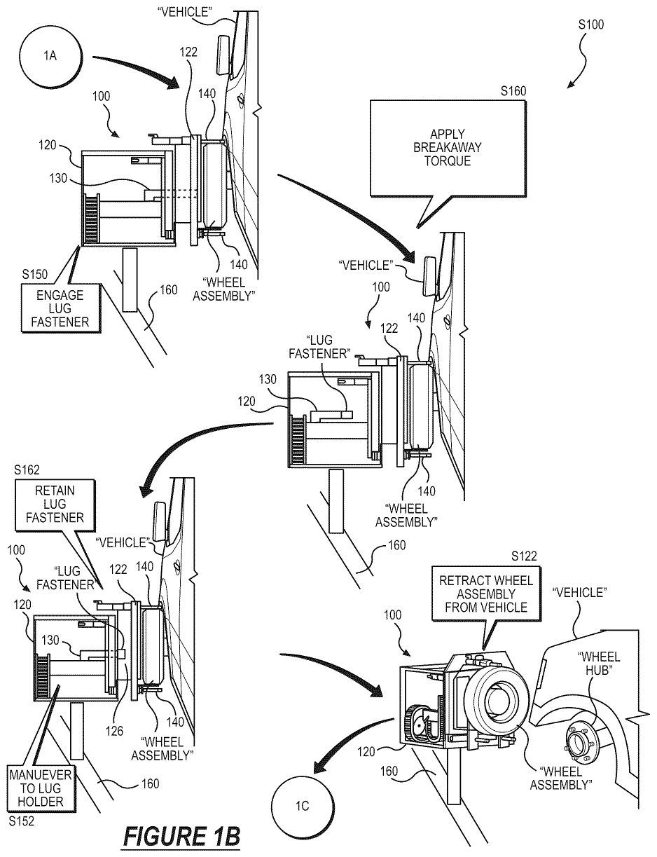

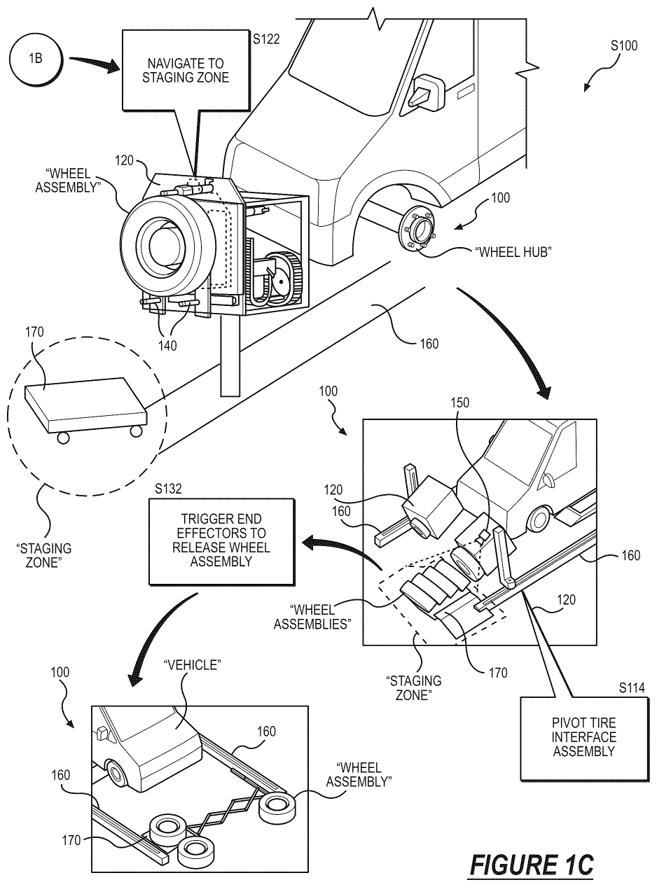

As shown in FIGS. 1A-1C, 2A, 2B, 5A, 5B, 6A, 6B, 7A, 7B, and 8, one variation of the system 100 includes: a tire interface assembly 120; and a set of actuators 160 configured to maneuver the tire interface assembly 120 along a vehicle, located adjacent the tire interface assembly 120, to locate the tire interface assembly 120 proximal a wheel assembly mounted to the vehicle.

The tire interface assembly 120 includes: an enclosure 122 defining a driver window 124; a set of lug holders 126 arranged within the enclosure 122 and configured to store threaded lug fasteners (e.g., lug nuts, lug bolts); a driver 130 arranged within the enclosure 122; a multi-axis driver actuator 132 configured to maneuver the driver 130 across the driver window 124; a set of end effectors 140 arranged on the enclosure 122 about the driver window 124; an external optical sensor 150; and an internal optical sensor 152.

The driver 130 is configured to apply a torque to a lug fastener, in a set of lug fasteners, securing the wheel assembly to a wheel hub of the vehicle located adjacent the tire interface assembly 120.

The multi-axis driver actuator 132 is configured to: laterally maneuver the driver 130 across the driver window 124; longitudinally maneuver the driver 130 through the driver window 124; and vertically maneuver the driver 130 across the driver window 124.

The set of end effectors 140 is configured to engage a tread of the wheel assembly to transiently retain the wheel assembly.

The external optical sensor 150: is arranged on the enclosure 122; and defines a first field of view external to the enclosure 122. The internal optical sensor 152: is arranged within the enclosure 122; and defines a second field of view intersecting the driver window 124.

The set of actuators 160 is configured to: maneuver the tire interface assembly 120 along the vehicle to locate the driver window 124 proximal a wheel disc of the wheel assembly; and pivot the tire interface assembly 120 to locate the driver window 124 substantially parallel and concentric with the wheel disc and locate a driver axis of the driver 130 substantially orthogonal to the wheel disc.

### 1.10 Variation: Image-Based Lug Fastener Manipulation

As shown in FIGS. 1A-1C, 2A, 2B, 5A, 5B, 6A, 6B, 7A, 7B, and 8, one variation of the system 100 includes: a tire interface assembly 120; and a set of actuators 160 configured to maneuver the tire interface assembly 120 along a vehicle located adjacent the tire interface assembly 120.

The tire interface assembly 120 includes: an enclosure 122 defining a driver window 124; a set of lug holders 126 arranged within the enclosure 122 and configured to store threaded lug fasteners; a set of end effectors 140 arranged on the enclosure 122 and configured to transiently retain a wheel assembly mounted to the vehicle located adjacent the tire interface assembly 120; an external optical sensor 150 arranged on the enclosure 122; an internal optical sensor 152 arranged within the enclosure 122; and a driver 130 arranged within the enclosure 122.

The internal optical sensor 152 is configured to capture a first image depicting lug fasteners securing the wheel assembly to a wheel hub of the vehicle. The external optical sensor 150 is configured to capture a second image depicting the wheel assembly mounted to the vehicle.

The driver 130 is configured to: maneuver across the driver window 124 to align to a position of a lug fastener depicted in the first image; maneuver through the driver window 124 to engage the lug fastener; apply a torque to the lug fastener to remove the lug fastener from a threaded lug stud of the wheel hub of the vehicle; and maneuver within the enclosure 122 to locate the lug fastener proximal a lug holder 126 in the set of lug holders 126.

The set of actuators 160 is configured to maneuver the tire interface assembly 120 along the vehicle to: locate the driver window 124 substantially parallel and concentric with a wheel disc of the wheel assembly depicted in the second image; and locate a driver axis of the driver 130 substantially orthogonal to the wheel disc of the wheel assembly.

### 2. Method

As shown in FIGS. 1A-1C, 2A, 2B, 3, and 4, a method S100 includes: navigating a tire interface assembly 120 along a work zone proximal a vehicle to locate an enclosure 122 of the tire interface assembly 120 proximal a wheel assembly mounted to the vehicle in Block S110; maneuvering the tire interface assembly 120 to locate a wheel disc of the wheel assembly substantially parallel and concentric with a driver window 124 defined in the enclosure 122 and within a field of view of an internal optical sensor 152 arranged within the enclosure 122 in Block S120; and triggering a set of end effectors 140, arranged on the enclosure 122 about the driver window 124, to engage a tread of the wheel assembly to transiently retain the wheel assembly in Block S130.

The method S100 also includes: accessing an image captured by the internal optical sensor 152 and depicting the wheel disc of the wheel assembly in Block S124; and detecting a lateral position and a vertical position of a lug fastener, securing the wheel assembly to a wheel hub of the vehicle, based on the image in Block S142.

The method S100 further includes: triggering a multi-axis driver actuator 132 to maneuver a driver 130, arranged within the enclosure 122, across the driver window 124 to align the driver 130 to the lateral position and the vertical position of the lug fastener in Block S150; triggering the multi-axis driver actuator 132 to drive the driver 130 through the driver window 124 to engage the lug fastener; and applying a breakaway torque to the lug fastener, via the driver 130, to loosen the lug fastener from a threaded lug stud of the wheel hub in Block S160.

The method S100 also includes: triggering the lug holder 126 to transiently retain the lug fastener in Block S152; and applying a tightening torque to the lug fastener, via the driver 130, to fasten the lug fastener to the lug holder 126 in Block S162.

### 3. Applications

Generally, a robotic system 100 (hereinafter “system 100”) configured to install proximal a vehicle lift (e.g., two-post or four-past lift, a low chassis lift) functions as an autonomous wheel assembly management system 100 for autonomously replacing and/or rotating wheel assemblies of a vehicle (e.g., a cargo vehicle, a passenger vehicle) loaded onto the vehicle lift. More specifically, rather than manually (i.e., by a mechanic) replacing and/or rotating wheel assemblies for vehicles (e.g., fleet of delivery vehicles), the system 100 is configured to autonomously replace and/or rotate wheel assemblies for vehicles. Accordingly, the system 100 can: reduce time and cost spent on servicing vehicles; minimize failure installations (e.g., incorrect lug fastener tightening, incorrect wheel assembly placement) of wheel assemblies on vehicles; and minimize exposure to risk (e.g., back strain, injury from improper lifting, tool related injuries) to an operator assigned to oversee tire replacement and rotation servicing for these vehicles.

The system 100 can include: a tire interface assembly 120 configured to transiently retain a wheel assembly - such as arranged at a vehicle loaded onto the vehicle lift - and to install/un-install lug fasteners coupled to lug studs of a wheel hub of the vehicle; a set of actuators 160 configured to maneuver and orient the tire interface assembly 120 about the vehicle (e.g., X, Y, Z positions, pitch, yaw) loaded onto the vehicle lift; and a controller configured to execute wheel replacement cycles and/or wheel rotation cycles for the vehicle.

The tire interface assembly 120 can include: an enclosure 122 defining a driver window 124 (e.g., aperture); a set of end effectors 140 (e.g., parallel jaw gripper) arranged about the driver window 124 of the enclosure 122 and configured to transiently retain the wheel assembly; an end effector actuator configured to rotate the set of end effectors 140 about the driver window 124 of the enclosure 122; an internal optical sensor 152 arranged within the enclosure 122 and defining a field of view intersecting the driver window 124; an external optical sensor 150 arranged proximal the driver window 124 and defining a field of view external to the enclosure 122; a driver 130 (e.g., impact driver 130) configured to apply a torque (e.g., breakaway torque, tightening torque) to a lug fastener arranged on the wheel assembly; and a multi-axis driver actuator 132 (e.g., set of linear actuators, set of rotary actuators) configured to maneuver the driver 130 to extend/retract from the driver window 124 of the enclosure 122. The set of actuators 160 can include: a set of linear actuators (e.g., longitudinal, lateral, vertical linear actuators) configured to maneuver the tire interface proximal the wheel assembly; and a set of rotary actuators (e.g., pitch actuators, yaw actuators) configured to orient the tire interface assembly 120 relative to the wheel assembly.

In one example, the system 100 includes: a left tire interface assembly 120 coupled to a left set of actuators 160 arranged proximal a left side of the vehicle lift; and a right tire interface assembly 120 coupled to a right set of actuators 160 arranged proximal a right side of the vehicle lift. In this example, the system 100 can concurrently install/un-install wheel assemblies arranged on the left side and right side of the vehicle.

### 3.1 Wheel Assembly Removal

During a wheel assembly removal cycle, the system 100 can: identify a position of the wheel assembly mounted to the vehicle; trigger the set of linear actuators to maneuver the tire interface assembly 120 to the position of the wheel assembly; access an image captured by the external optical sensor 150 depicting the wheel assembly at the vehicle; extract a set of visual features from the image; generate a point cloud representation of the wheel assembly based on the set of visual features; and derive a plane approximation of a wheel face of a wheel disc according to the point cloud representation. The system 100 can then trigger the set of linear actuators and the set of rotary actuators to locate the tire interface assembly 120 at a target pose to orient the driver 130 orthogonal to the plane approximation of the wheel face.

In one example, system 100 can then: access a vehicle specification (e.g., make, model, lug fastener size, torque tightening limit, fastening pattern) corresponding to the vehicle, such as based on a license plate number and/or vehicle identification number (or “VIN”) associated with the vehicle; trigger the set of end effectors 140 to transiently retain the wheel assembly; access an image captured by the internal optical sensor 152 and depicting the wheel face of the wheel disc; detect a set of lug fasteners in a set of regions of the image; identify positions, corresponding to the set of regions, of the set of lug fasteners on the wheel face; trigger the driver 130 to apply a breakaway torque—according to a fastening pattern specified in the vehicle specification—across the set of lug fasteners; and trigger the set of actuators 160 to maneuver the wheel assembly, retained by the tire interface assembly 120, toward a tire cart 180 or a tire storage system arranged proximal the vehicle lift. Therefore, the system 100 can accurately and repeatably un-install a wheel assembly arranged at a vehicle loaded onto the vehicle lift.

### 3.2 Wheel Assembly Install+Tire Cart Rotation

During a wheel install cycle, the system 100 can: identify a position of a wheel assembly—loaded on a storage rack of a tire cart 180—for installation at a wheel hub of the vehicle; and trigger the set of linear actuators and the set of rotary actuators to maneuver the tire interface assembly 120 to the position of the wheel assembly on the storage rack of the tire cart 180.

In one example, the wheel assembly for installation at the wheel hub corresponds to a new wheel assembly pre-loaded onto a first side of the storage rack. In this example, the tire cart 180 can trigger the cart actuators 182 to maneuver (e.g., translate) the first side of the storage rack proximal the tire interface assembly 120. In another example, such as for a non-directional tire rotation, the wheel assembly for installation at the wheel hub corresponds to a previously un-installed wheel assembly (e.g., uninstalled by a second instance of the tire interface assembly 120 and the set of actuators 160 arranged on a second side of the vehicle lift) loaded onto a second side of the storage rack by the system 100. In this example, the controller can trigger the set of cart actuators 182 to rotate the tire cart 180 (e.g., half rotation) to locate the previously un-installed wheel assembly on the second side of the storage rack proximal the tire interface assembly 120.

The system 100 can then implement steps described above to, via the set of linear actuators and the set of rotary actuators, locate the tire interface assembly 120 at a target pose to orient the driver 130 orthogonal to a plane approximation of the wheel face of the wheel disc of a wheel assembly at the tire cart 180.

The system 100 can then: trigger the set of actuators 160 to maneuver the wheel assembly, via the set of end effectors 140, proximal a wheel hub of the vehicle; access an image captured by the external optical sensor 150 depicting the wheel hub; and implement computer vision techniques (vector calculation, plane approximation) to detect orientations and positions of lug studs protruding from the wheel hub based on the image. The system 100 can then, based on these positions and orientations, derive a target pose for the tire interface assembly 120—holding the wheel assembly—that locates: the driver window 124, and therefore the wheel disc of the wheel assembly—substantially parallel to the threaded lug studs; locates the driver 130 coaxial with the threaded lug studs; and locates lug fastener apertures of the wheel assembly in alignment with the threaded lug studs. The system 100 can then: trigger the set of rotary actuators to locate the tire interface assembly 120 at the target pose; and trigger the set of linear actuators to maneuver the wheel assembly, via the set of end effectors 140, toward the wheel hub.

The system 100 can then: trigger the multi-axis driver actuator 132 assembly to maneuver the driver 130 proximal a lug holder 126 coupled to the enclosure 122 of the tire interface assembly 120; trigger the driver 130 to retrieve a lug fastener from the lug holder 126; trigger the multi-axis driver actuator 132 to maneuver the driver 130 proximal a threaded lug stud at the wheel hub; and trigger the driver 130 to apply a torque to seat (i.e., prior to applying torquing limit) the lug fastener at the threaded lug stud. The system 100 can then: repeat this process for a set of lug fasteners and a set of threaded lug studs at the wheel hub according to a fastening pattern, such as extracted from the vehicle specification; and trigger the driver 130 to apply a torque to the set of lug fasteners according to a torquing limit and the fastening pattern. Additionally, the system 100 can: generate a report representing applied torque across the set of lug fasteners; and transmit this report to an operator overseeing installation of the wheel assembly onto the vehicle.

Therefore, the system 100 can accurately and repeatably install a wheel assembly to the vehicle loaded at the vehicle lift, such as to install a new wheel assembly and/or rotate wheel assemblies on the vehicle.

The system 100 is described herein as autonomously rotating and changing tires of a vehicle. However, the system 100 can additionally or alternatively rotate and/or change tires of other wheeled vehicles, such as trucks, passenger cars, and/or trailers, etc.

### 3.3 Autonomous Wheel Service Efficiency

In one implementation, the system 100 is configured to autonomously execute a wheel replacement or rotation cycle, thereby eliminating manual intervention during wheel removal and installation operations. The system 100 can, during a service cycle, identify a wheel assembly mounted to a vehicle loaded onto a vehicle lift, unfasten a set of lug fasteners securing the wheel assembly to a wheel hub, and subsequently install a second wheel assembly at the wheel hub. In this implementation, the system 100 can standardize cycle time and torque accuracy across vehicles serviced by the same platform, thereby reducing operational variability introduced by manual technicians.

Furthermore, the system 100 is configured to reduce total service time by minimizing non-productive movement of tooling components. In particular, the system 100 can integrate a driver 130, a set of lug holders 126, and a set of socket holders 128 within an enclosure 122 of the tire interface assembly 120. Thus, the driver 130 can retrieve and re-seat the same set of lug fasteners, previously removed from a first wheel assembly, for installation of a second wheel assembly, thereby eliminating tool exchanges and repositioning operations. Accordingly, the system 100 can complete wheel removal and installation sequences at reduced traversal speeds without reducing overall throughput.

Additionally, the system 100 can reduce physical strain and injury risk to service personnel by eliminating manual wheel handling operations. The system 100 can execute wheel service cycles without direct human contact with wheel assemblies or power tools, thereby mitigating back strain, repetitive-motion injuries, and torque-related hazards associated with conventional wheel service operations.

Additionally, the system 100 can increase operational efficiency across a range of service environments. For example, the system 100 can: reduce maintenance downtime and improve consistency of wheel-service operations for fleet operators and/or vehicle owners; increase throughput per lift station; and maintain digital records representing torque application and wheel-installation events for service-center operators. Therefore, the system 100 can improve efficiency, safety, and traceability across autonomous and semi-autonomous wheel-service operations.

### 4. Terms/Definitions

Generally, a “wheel assembly” as referred to herein is a unit of a wheel-tire assembly that can include a tire (e.g., a rubber tire), a rim, and a hub.

Generally, a “wheel hub” as referred to herein is the part of a vehicle's suspension that couples to a wheel-tire assembly and can include a roller and lug studs.

Generally, a “wheel disc” as referred to herein is the central portion of the wheel assembly that connects to the wheel hub of the vehicle.

### 5. System

Generally, the system 100 is configured to locate proximal a vehicle and includes: a tire interface assembly 120 configured to interface with a wheel assembly (e.g., mounted to a vehicle loaded onto the vehicle lift) to install/un-install lug fasteners that secure the wheel assembly to a wheel hub of the vehicle; a set of actuators 160 (e.g., a set of actuators 160) configured to maneuver the tire interface assembly 120 along the vehicle; and a controller configured to execute wheel removal cycles, wheel installation cycles, wheel replacement cycles and/or wheel rotation cycles for the vehicle loaded onto the vehicle lift.

In one example, the system 100 is configured to transiently install proximal a vehicle lift (e.g., a two post lift, a scissor lift), such as via fasteners and/or clamps. In another example, the system 100 is configured to permanently install proximal the vehicle lift (e.g., via welding). In yet another example, the system 100 can include a module platform including: the tire interface assembly 120; the set of actuators 160; and a vehicle lift. In this example, the module can be transported, such as between different work zones (e.g., within a service facility).

### 5.1 Tire Interface Assembly

As shown in FIGS. 1A-1C, 2A, 2B, 5A, 5B, 6A, 6B, 7A, 7B, and 8, the tire interface assembly 120 can include: an enclosure 122 defining a driver window 124 (e.g., circular aperture); a driver 130 (e.g., impact driver 130) arranged within the enclosure 122 and configured to apply a torque (e.g., breakaway torque) to a lug fastener; a multi-axis driver actuator 132 (e.g., X, Y, Z linear actuators) arranged within the enclosure 122 and configured to maneuver the driver 130 about the driver window 124 and to extend/retract the driver 130 through the driver window 124; a moment sensor coupled to the driver 130 and configured to output torque values during torque application by the driver 130 (i.e., to a lug fastener); a set of optical sensors; a set of end effectors 140 (e.g., parallel jaw grippers) coupled to the enclosure 122 and arranged about the driver window 124; an end effector actuator coupled to the set of end effectors 140 and configured to rotate the set of end effectors 140 about the driver window 124; a set of lug holders 126 arranged within the enclosure 122 and configured to store a set of lug fasteners, such as a new set of lug fasteners and/or lug fasteners previously removed from a wheel assembly; and a set of socket holders arranged within the enclosure 122 and configured to store sockets. The tire interface assembly 120 is configured to autonomously install/un-install lug fasteners at a wheel assembly, as described below.

The multi-axis driver actuator 132 is configured to: laterally maneuver the driver 130 across the driver window 124; longitudinally maneuver the driver 130 through the driver window 124; and vertically maneuver the driver 130 across the driver window 124. Additionally, the multi-axis driver actuator 132 is configured to maneuver the driver 130 within the enclosure 122 between the driver window 124, the set of lug holders 126, and the set of socket holders. Thus, the tire interface assembly 120 can be configured to store lug fasteners (e.g., recently removed from a wheel assembly) and sockets, such that the driver 130 can rapidly remove, store, and retrieve lug fasteners (i.e., without leaving the enclosure 122) during wheel replacement cycles.

### 5.1.1 Threaded Lug Storage

In one implementation, the tire interface assembly 120 can include a set of lug holders 126, arranged within the enclosure 122, similar to lug holders 126 described in U.S. Provisional Application No. 63/896,606, filed on 9 Oct. 2025, which is incorporated in its entirety by this reference. For example, the tire interface assembly 120 can include a set of multi-jaw chucks 126 (e.g., self-centering three-jaw chucks) arranged within the enclosure and configured to: transiently retain both threaded lugs and lug bolts previously removed from a wheel assembly; and/or transiently retain either new threaded lugs or lug bolts, such as retrieved from a threaded lug hopper arranged within the enclosure. In this example, the system 100 can: trigger the multi-axis driver actuator 132 to maneuver a threaded lug removed from the wheel assembly proximal a multi-jaw chuck 126 in the set of multi-jaw chucks 126; and drive the jaws of the multi-jaw chuck 126 to transiently retain the threaded lug.

In one example, the system 100 can: maneuver the threaded lug, via the multi-axis driver actuator 132 and the driver 130, removed from the wheel assembly to insert an aperture of the threaded lug through the jaws of the multi-jaw chuck 126; and trigger the jaws of the multi-jaw chuck 126 to expand in order to transiently retain the threaded lug. In another example, the system 100 can: maneuver the threaded lug, via the multi-axis driver actuator 132 and the driver 130, removed from the wheel assembly to locate the threaded lug within open jaws of the multi-jaw chuck 126; and trigger the multi-jaw chuck to drive the jaws toward the threaded lug in order to transiently retain the threaded lug.

In one example, the set of lug holders 126 can include a multi-jaw chuck 126 including a set of jaws operable in: a closed position; and an open position. In this example, during a first time period: the multi-jaw chuck is configured to contract the set of jaws to the closed position; the multi-axis driver actuator is configured to maneuver the driver to locate the lug fastener, transiently retained by the driver, on the set of jaws in the closed position; and the multi-jaw chuck is configured to expand the set of jaws to the open position to transiently retain internal threads of the lug fastener. Furthermore, during a second time period: the multi-jaw chuck is configured to expand the set of jaws to the open position; the multi-axis driver actuator is configured to maneuver the driver to locate a lug bolt, transiently retained by the driver, within the set of jaws in the open position; and the multi-jaw chuck is configured to contract the set of jaws to the closed position to transiently retain external threads of the lug bolt.

In another example, the set of lug holders 126 can include a set of inflatable grippers arranged within the enclosure 122, each configured to insert into, expand (e.g., pneumatically) within, and thus transiently retain a threaded lug. In this example, each inflatable gripper can include: a tube (e.g., a cylindrical tube); a bladder (e.g., an elastomeric bladder) forming an inflatable nipple and arranged on a proximal end of the tube; an inlet port arranged on a distal end of the tube and coupled to an air supply; and a control valve configured to selectively supply compressed air from the air supply to the inlet port of the tube to inflate the bladder. Accordingly, the system 100 can: maneuver the threaded lug, via the multi-axis driver actuator and the driver, removed from the wheel assembly to insert the aperture of the threaded lug through the bladder of the inflatable gripper; and trigger the control valve to supply air to the inlet port to inflate the bladder and transiently retain the threaded lug.

Therefore, the tire interface assembly 120 can transiently retain threaded lugs removed from a tire assembly by engaging the threaded lugs without threading engagement, thereby preventing thread wear or cross-threading during transient retention of the threaded lugs within the enclosure 122 of the tire interface assembly 120.

### 5.1.2 End Effectors

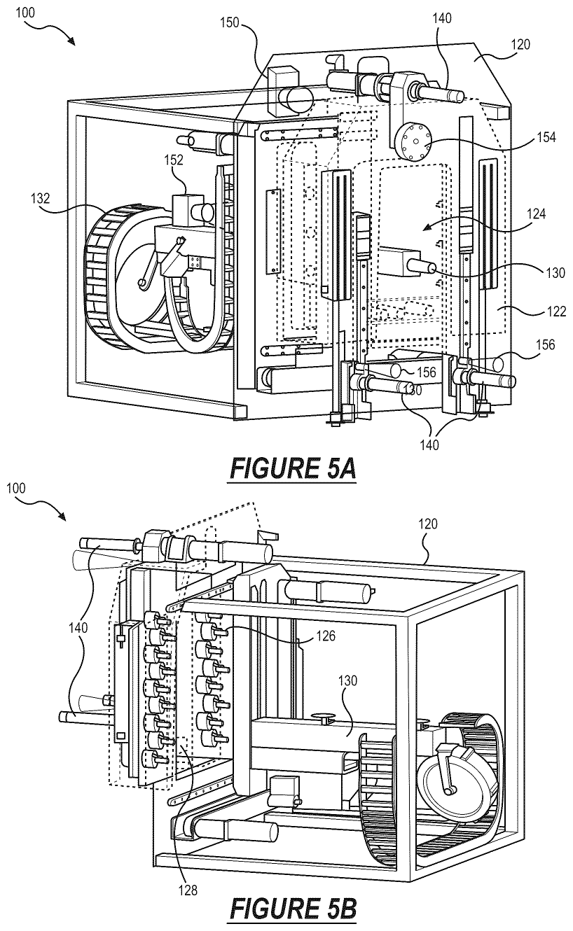

The set of end effectors 140 is arranged on the enclosure 122 about the driver window 124 and configured to engage a tread of a wheel assembly to transiently retain the wheel assembly. In particular, the set of end effectors 140 can include: a set of (i.e., one or more) upper end effectors 140 arranged on the enclosure 122 and located above the driver window 124; and a set of (i.e., one or more) lower end effectors 140 arranged on the enclosure 122 and located below the driver window 124. In one example, as shown in FIG. 5A, the set of end effectors 140 includes a set of three end effectors 140 (e.g., roller-grippers, prongs) including: a pair of upper end effectors 140 arranged on the enclosure 122 and located above the driver window 124; and a lower end effector arranged on the enclosure 122 and located below the driver window 124.

The set of end effectors 140 is operable in: an open position, wherein the set of end effectors 140 is spaced apart to clear the outer diameter of the wheel assembly; and a closed position, wherein the set of end effectors 140 converges to contact the tread and retain the wheel assembly. In particular, the set of end effectors 140 is configured to: drive toward a wheel assembly in the open position; and transition from the open position to the closed position to transiently retain (e.g., grip) the wheel assembly. More specifically, the tire interface assembly 120 can be configured to locate proximal a wheel assembly, with the set of end effectors 140 in the open position, such that: the wheel disc of the wheel assembly is located substantially concentric with the driver window 124 of the enclosure 122; the set of upper end effectors 140 are aligned to an annular gap between the wheel assembly and the structure (e.g., a fender) surrounding the wheel assembly; and the set of lower end effectors 140 are aligned to a gap below the wheel assembly.

In one variation, the set of lower end effectors 140 is arranged on an end effector actuator configured to locate the lower end effector over a range of vertical positions to accommodate a range of wheel diameters (e.g., between 13 inches and 40 inches).

In another variation, the set of end effectors 140 includes: a set of upper end effectors 140; and a set of lower end effectors 140 configured to locate over a range of vertical positions. In this variation, the set of end effectors 140 is configured to operate in: a first position to transiently retain wheel assemblies exhibiting diameters within a first diameter range (e.g., between 13 inches and 25 inches); and a second position to transiently retain wheel assemblies exhibiting diameters within a second diameter range (e.g., between 25 inches and 40 inches) greater than the first diameter range.

For example, the set of lower end effectors 140 can include a bistable linkage configured to lock in a raised or lowered position to accommodate these wheel diameter ranges. In another example, the set of lower end effectors 140 can include a manually adjustable mount configured to reposition the lower end effectors 140 along a vertical rail prior to operation. In another example, the set of lower end effectors 140 can include an actuator configured to autonomously reposition the lower end effectors 140 along a vertical axis, such as based on a detected wheel diameter.

Accordingly, the set of end effectors 140 can be configured to dynamically adapt to wheel assemblies exhibiting different diameters such that the system 100 can autonomously execute wheel assembly removal and installation cycles over a range of vehicles (e.g., cargo vehicles, passenger vehicles).

### 5.1.3 Force Sensors+Depth Sensors

The tire interface assembly 120 can include a force sensor 154: coupled to the set of end effectors 140; and configured to output signals representing forces exerted on the set of end effectors 140, such as during approach and retraction of the set of end effectors 140 and/or during retention of a wheel assembly at the tire interface assembly 120. In one example, the force sensor 154 can detect transient increases in load during approach to interpret interference between the set of end effectors 140 and a surrounding vehicle structure (e.g., a fender). In another example, the force sensor 154 can detect reductions in load during retention to interpret loss of wheel engagement by the set of end effectors 140. In yet another example, the force sensor 154 can output a continuous signal representing applied gripping force, which the controller can compare to a nominal range characteristic of wheel retention to verify secure engagement prior to retraction.

Additionally, the tire interface assembly 120 can include a set of depth sensors 156: arranged on the enclosure 122 proximal the set of end effectors 140; and configured to output signals representing distances between the enclosure 122 (e.g., a reference plane of the enclosure 122) and a sidewall of a wheel assembly. In one example, the controller can access signals output by the set of depth sensors 156 to generate a plane approximation of a wheel disc. In another example, the controller can compare distances represented in the signals across multiple depth sensors 156 to interpret nonuniform change in wheel proximity indicative of axial misalignment between the wheel assembly and the wheel hub. In yet another example, the controller can store distances represented in the signals as a reference for installing a replacement wheel assembly at the same position.

### 5.1.4 Optical Sensors

As shown in FIG. 5A, the set of optical sensors includes: an external optical sensor 150 (e.g., color camera, depth sensor, LIDAR sensor) arranged at an outer facet of the enclosure 122 proximal the driver window 124 and defining a field of view external to the enclosure 122; and an internal optical sensor 152 (e.g., color camera, depth sensor, LIDAR sensor) arranged within the enclosure 122 and defining a field of view of the driver window 124.

The external optical sensor 150 is: arranged on an exterior of the enclosure 122; and configured to capture images depicting objects and surfaces proximal the tire interface assembly 120. For example, the external optical sensor 150 can capture images depicting positions and orientations of wheel assemblies mounted to the vehicle. In one example, the system 100 can: capture an image of a side of the vehicle via the external optical sensor 150; detect a wheel assembly in a region in the image; interpret a lateral position of the wheel assembly based on the image; and maneuver the tire interface assembly 120 to the lateral position.

The internal optical sensor 152 is: arranged within an interior of the enclosure 122; and configured to capture images depicting objects and surfaces proximal the driver window 124. For example, the internal optical sensor 152 can capture images depicting positions of lug fasteners of wheel assemblies retained by the set of end effectors 140. In one example, the system 100 can: capture an image of a wheel disc of the wheel assembly retained by the tire interface assembly 120 via the internal optical sensor 152; detect a lateral position and a vertical position of a lug fastener, securing the wheel assembly to a wheel hub of the vehicle, based on the image; and trigger the multi-axis driver actuator 132 to maneuver the driver 130 across the driver window 124 to align the driver 130 to the lateral position and the vertical position of the lug fastener. In one example, the internal optical sensor 152 can be integrated with the driver 130. In this example, the multi-axis driver actuator 132 can maneuver the driver 130 and the internal optical sensor 152 within the driver window 124.

Accordingly, the system 100 can: leverage images captured by the external optical sensor 150 to derive coarse positional and angular alignment of the tire interface assembly 120 relative to the vehicle and wheel hub; and leverage images captured by the internal optical sensor 152 to derive fine positional alignment of the driver 130 relative to lug fasteners on the wheel disc.

In one variation, the set of optical sensors further includes a stationary optical sensor (e.g., color camera, depth sensor, LIDAR sensor) arranged proximal the vehicle lift and defining a field of view of a side of the vehicle loaded onto the vehicle lift. In one example, the system 100 can: capture an image of a side of the vehicle via the stationary optical sensor; detect a wheel assembly in a region in the image; interpret a lateral position of the wheel assembly based on the image; and maneuver the tire interface assembly 120 to the lateral position.

In one variation, the set of optical sensors further includes an internal optical sensor (e.g., a 2D color camera; a 1D depth sensor): arranged within the enclosure 122; defining a field of view orthogonal to and intersecting a traversal path of a socket driven by the driver 130; and configured to output a distance or image representing presence of a lug nut or a lug bolt in the docket as the driver 130 retracts the socket into to the enclosure 122 in preparation for storing contents of the driver 130 (i.e., a lug nut or lug bolt) inside of the enclosure.

### 5.2 Set of Actuators

The system 100 includes a set of actuators 160 configured to: maneuver the tire interface assembly 120 along the vehicle loaded onto the vehicle lift, such as by maneuvering the tire interface assembly 120 about a length, a width, and a height of the vehicle; and orient the tire interface assembly 120 at a target pose relative a wheel assembly (e.g., a wheel assembly mounted to the vehicle). For example, the set of actuators 160 can maneuver the tire interface assembly 120 through multiple degrees of freedom, such as longitudinal, latitudinal, and vertical translation, and yaw, pitch, and roll rotation, such that the tire interface assembly 120 can achieve fine-grained alignment to wheel assemblies exhibiting non-uniform height, camber, or angular offset relative to the vehicle.

In one implementation, the set of actuators 160 can include: a longitudinal actuator (e.g., linear conveyor) configured to maneuver the tire interface assembly 120 across a length of the vehicle lift; a yaw actuator (e.g., stepper motor, servo motor) coupled to the longitudinal actuator and configured to rotate the tire interface assembly 120 about a yaw axis; an elevator (e.g., vertical linear actuator) coupled to the yaw actuator and configured to maneuver the tire interface assembly 120 across a height of the vehicle loaded onto the vehicle lift; a pitch actuator (e.g., stepper motor, servo motor) coupled to the elevator and configured to rotate (or “pitch”) the tire interface assembly 120 about a pitch axis; and a latitudinal actuator (e.g., linear actuator) coupled to the pitch actuator and configured to extend/retract the tire interface assembly 120 from the vehicle.

In particular, in this implementation, the controller can trigger the set of actuators 160 to: maneuver the tire interface assembly 120 to a particular position (e.g., X, Y, Z coordinate position) proximal the vehicle lift; and orient the tire interface assembly 120 (e.g., pitch orientation, yaw orientation) relative a wheel assembly, such as to align the driver 130 substantially orthogonal to a wheel plane of the wheel assembly.

In one implementation, the set of actuators 160 can be configured to pivot the tire interface assembly 120 (e.g., between −5° and 90°) through a plane of rotation to orient the tire interface assembly 120 to retrieve a wheel assembly (e.g., from a ground surface), install wheel assemblies at a target pitch angle, and/or deliver a wheel assembly (e.g., proximal a ground surface). For example, the set of actuators 160 can be configured to: maneuver the tire interface assembly 120 along the vehicle to locate the driver window 124 substantially parallel and concentric with a wheel disc of a wheel assembly mounted to the vehicle and selected for removal from the vehicle; and pivot the tire interface assembly 120 to locate a driver axis of the driver 130 substantially orthogonal to the wheel disc of the wheel assembly.

### 5.3 Mobile Platform

In one variation, the system 100 includes: a mobile platform configured to traverse a ground surface within the work zone; and a tire interface assembly 120 mounted to the mobile platform. In this variation, the mobile platform can incorporate the set of actuators 160 to maneuver the tire interface assembly 120 through translational motion along longitudinal, latitudinal, and vertical axes, and rotational motion about yaw, pitch, and roll axes.

In particular, in this variation, the mobile platform can be configured to autonomously: maneuver the tire interface assembly 120 along a left side of the vehicle to interface with wheel assemblies arranged at a left side of a vehicle arranged on the vehicle lift; and maneuver the tire interface assembly 120 along a right side of the vehicle to interface with wheel assemblies arranged at a right side of the vehicle. Thus, in this variation, the system 100 can implement a single instance of the tire interface assembly 120 to remove and replace wheel assemblies located on the left and right sides of the vehicle.

### 5.4 Dual-Sided System

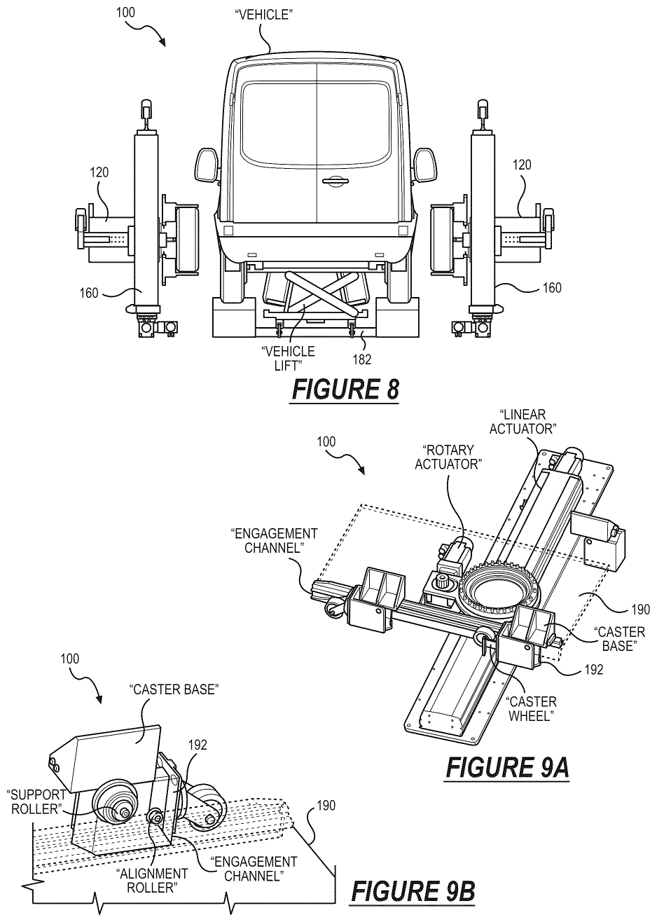

In one variation, as shown in FIG. 8, the system 100 can include: a left tire interface assembly 120 configured to interface with wheel assemblies arranged at a left side of a vehicle arranged on the vehicle lift; and a right tire interface assembly 120 configured to interface with wheel assemblies arranged at a right side of the vehicle arranged on the vehicle lift. In this variation, the system 100 can further include: a left set of actuators 160 configured to maneuver the left tire interface assembly 120 along a left side of the vehicle; and a right set of actuators 160 configured to maneuver the right tire interface assembly 120 along a right side of the vehicle.

In another variation, the system 100 can include a set of actuators 160 configured to maneuver the tire interface assembly 120 along left and right sides of the vehicle, such as in a U-shaped configuration. In this variation, rather than implementing two instances of the tire interface assembly 120 (e.g., a left tire interface assembly 120 and a right tire interface assembly 120), the system 100 can implement a single instance of the tire interface assembly 120 to remove and replace wheel assemblies located on the left and right sides of the vehicle.

### 5.5 Storage Trolley

In one variation, as shown in FIG. 1C, the system 100 includes a storage trolley 170 configured to: transiently store wheel assemblies; and laterally traverse a ground surface within the work zone to transfer wheel assemblies between sides of the vehicle. For example, the storage trolley 170 can transiently store a wheel assembly previously uninstalled from the vehicle, or a new wheel assembly for installation onto the vehicle. In particular, the storage trolley 170 can be configured to locate between a left linear track located proximal a left side of the vehicle and a right linear track located proximal a right side of the vehicle.

The storage trolley 170 can include: a platform configured to transiently store wheel assemblies; a set of wheels mounted to the platform; a scissor arm interposed between the platform and a linear track (e.g., the right linear track or the left linear track); and a trolley actuator configured to extend and retract the scissor arm to transfer the storage trolley 170 from a first side (e.g., the left side) of the vehicle to proximal a second side (e.g., the right side) of the vehicle. In one example, the platform defines a planar surface configured to receive and store a set of stacked wheel assemblies. In another example, the platform can define a set of slots (e.g., diagonal slots) configured to store wheel assemblies.

In one example, the storage trolley 170 can be configured to locate between the left linear track and the right linear track and proximal a forward region of the vehicle offset from an engine compartment of the vehicle (e.g., to maintain clearance from an operator workspace proximal the engine compartment). In another example, the storage trolley 170 can be configured to locate between the left linear track and the right linear track and proximal a rear region of the vehicle (e.g., to maintain clearance from the vehicle lift and operator workspace). In another example, the system 100 includes: a first storage trolley 170 located between the left linear track and the right linear track and proximal the forward region of the vehicle; and a second storage trolley 170 located between the left linear track and the right linear track and proximal the rear region of the vehicle.

### 5.6 Tire Cart

In one variation, the system 100 includes a tire cart 180 configured to store a set of wheel assemblies (e.g., new wheel assemblies, wheel assemblies previously removed from a vehicle). The tire cart 180 can include: a base (e.g., rectilinear base); a set of wheels (e.g., casters, rollers) arranged at corners of the base; a tire cart 180 arranged above and pivotably coupled to the base and including a set of slots configured to transiently store wheel assemblies; and a latch configured to selectively retain an angular position of the storage rack on the base and to release the storage rack to rotate on the base. The storage rack includes: a first set of slots (or wheel assembly cubbies, receivers, receptacles, retainers) arranged on a first side of the storage rack and configured to support wheel assemblies; and a second set of slots arranged on a second side of the storage rack, opposite the first side, and configured to support a second set of wheel assemblies.

In one example, the storage rack includes indicia (e.g., markings, color codes, QR codes) configured to indicate designation of the wheel assembly (e.g., left-front wheel assembly, right-rear wheel assembly). In this example, the set of slots can include: bottom slots configured to receive new wheel assemblies; and top slots configured to receive used wheel assemblies (e.g., removed from the vehicle).

In one example, prior to execution of a tire rotation or tire replacement, an operator can manually: load a set of wheel assemblies into slots of the storage rack; and locate the tire cart 180 proximal the tire interface assembly 120. In another example, during execution of the tire rotation or tire replacement, the system 100 can autonomously locate wheel assemblies removed from the vehicle into the slots of the storage rack. An operator may then manually maneuver the storage rack, containing the loaded wheel assemblies, to a tire staging zone and/or to a tire inspection station. Accordingly, the tire cart 180 is configured to receive and store wheel assemblies designated for installation onto the vehicle and/or removed from the vehicle by the tire interface assembly 120.

### 5.7 Cart Receptacle

In one variation, the system 100 further includes a tire cart 180 receptacle: configured to locate adjacent the set of actuators 160; and configured to receive and retain the tire cart 180. In this implementation, the tire cart 180 receptacle includes a set of cart actuators 182 configured to release the latch of the tire cart 180 and to rotate the storage rack on the base of the tire cart 180 to selectively expose the first set of slots and the second set of slots of the tire cart 180 to the tire interface assembly 120.

In one example, the set of cart actuators 182 includes: a linear actuator (e.g., conveyor) extending between a primary instance of the set of actuators 160 arranged at a primary side of the vehicle lift and a secondary instance of the set of actuators 160 arranged at a secondary side, opposite the first side, of the vehicle lift; and a rotary actuator coupled to the base of the tire cart 180 that rotates the tire cart 180. The tire cart 180 receptacle can further include a locking mechanism (e.g., locking pin, retention features, pinning gear) that can be selectively engaged by an operator to retain the tire cart 180 at the tire cart 180 receptacle.

In one example, an operator may manually load the tire cart 180 at the tire cart 180 receptacle. The controller can then trigger the set of cart actuators 182 to maneuver the first set of slots of the storage rack proximal the tire interface assembly 120. In this example, the first set of slots can: contain wheel assemblies (e.g., new wheel assemblies) pre-loaded by an operator; or correspond to empty slots that receive wheel assemblies from the tire interface assembly 120. The controller can then trigger the set of cart actuators 182 to selectively expose the first set of slots and the second set of slots of the tire cart 180 to the tire interface assembly 120. Therefore, the system 100 can include a tire cart 180 receptacle to selectively locate a first set of slots and a second set of slots proximal the tire interface assembly 120 during a wheel rotation cycle or a wheel replacement cycle.

### 6. Wheel Assembly Removal

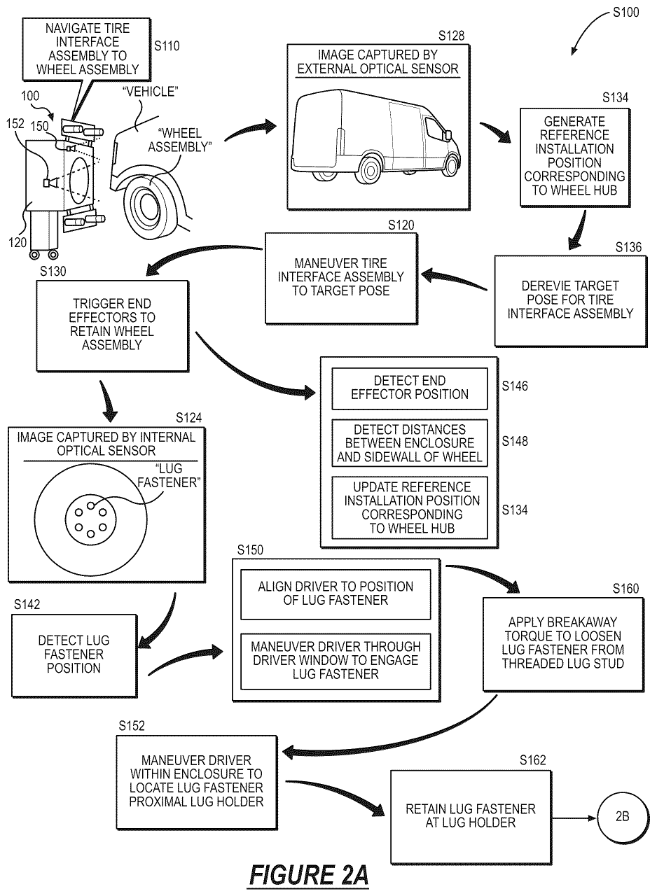

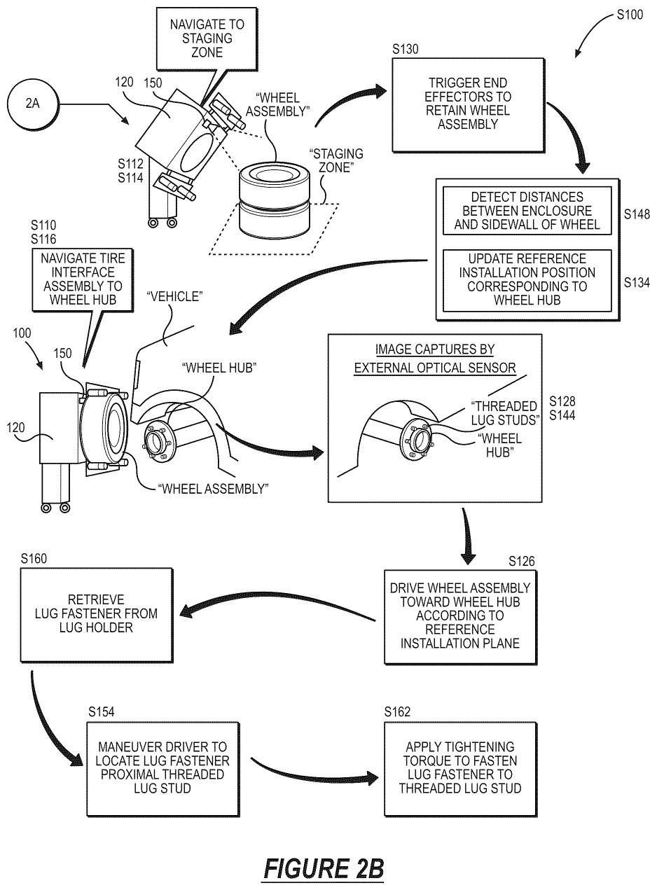

Generally, as shown in FIGS. 1A-1C and 2A, the system 100 can execute a wheel removal cycle to: retain the wheel assembly via the set of end effectors 140; remove a set of lug fasteners, securing a wheel assembly to a wheel hub of the vehicle, via the driver 130; and retract the wheel assembly away from the vehicle to remove the wheel assembly from the vehicle.

### 6.1 Vehicle Ingest

Generally, the system 100 can: detect a vehicle located on the vehicle lift and/or receive confirmation from an operator of presence of the vehicle on the vehicle lift; and initiate a wheel removal cycle to uninstall wheel assemblies mounted to the vehicle.

In one example, prior to initiating a wheel removal cycle, the system 100 can generate a notification requesting an operator to: trigger the vehicle lift to lift the vehicle; and remove hubcaps from wheel assemblies of the vehicle. The system 100 can then serve this prompt to the operator, such as to a device (e.g., tablet, integrated display, mobile device) accessed by the operator. The system 100 can then: receive confirmation of completion of the steps indicated in the prompt; and initiate the wheel removal cycle.

In one implementation, in response to confirmation of presence of the vehicle on the vehicle lift, the system 100 can: trigger the set of actuators to navigate the tire interface assembly along a length of the vehicle; trigger the external optical sensor to capture an optical scan of the vehicle as the tire interface assembly traverses the length of the vehicle; detect wheel assemblies mounted on the vehicle based on the optical scan; and select a wheel assembly for removal from the vehicle. For example, the system 100 can interpret the optical scan to detect circular and annular features characteristic of wheel assemblies; identify a quantity and relative spacing of wheel assemblies along the vehicle; and classify each wheel assembly by accessibility or wheel type to prioritize and select a target wheel assembly for removal.

### 6.2 Gross Positioning

Block S110 of the method S100 recites navigating a tire interface assembly 120 along a work zone proximal a vehicle to locate an enclosure 122 of the tire interface assembly 120 proximal a wheel assembly mounted to the vehicle. Generally, in Block S110, the system 100 can navigate within the work zone to locate the tire interface assembly 120 proximal a wheel assembly selected for removal from the vehicle.

In one implementation, the controller can: access an image captured by the external optical sensor 150 arranged on the enclosure 122 and depicting the wheel assembly mounted to the vehicle; interpret a target gross position that locates the tire interface assembly 120 proximal the wheel assembly; and trigger the set of actuators 160 to locate the tire interface assembly 120 proximal the target gross position.

In one example, the controller can: access an image (e.g., overview image, full-view image) captured by the external optical sensor 150 and depicting a left side of a vehicle; and implement computer vision techniques (e.g., object detection) to detect a left-front wheel assembly in a region of the image. The system 100 can then: interpret a target gross position that locates the tire interface assembly 120 proximal and offset (e.g., 0.6 feet) from the left-front wheel assembly; and trigger the set of actuators 160 to maneuver the tire interface assembly 120 to the target gross position.

For example, the controller can interpret a target gross position representing a three-dimensional coordinate position proximal the left-front wheel assembly of the vehicle. In this example, the three-dimensional coordinate position defines: a target lateral position along the periphery of the vehicle lift; a target longitudinal position (e.g., a depth) from the vehicle; and a target vertical position (e.g., relative to a ground surface of the work zone). The controller can then: trigger a longitudinal actuator to navigate the tire interface assembly 120 to the target lateral position; trigger a latitudinal actuator to navigate the tire interface assembly 120 to the target longitudinal position; and trigger an elevator to navigate the tire interface assembly 120 to the target vertical position.

### 6.3 Target Pose

Blocks of the method S100 recite: accessing an image captured by an external optical sensor 150 arranged on the enclosure 122 and depicting the wheel assembly mounted to the vehicle in Block S128; generating a plane approximation of the wheel disc of the wheel assembly based on the image in Block S134; deriving a target pose for the tire interface assembly 120 based on the plane approximation in Block S136; and maneuvering the tire interface assembly 120 to the target pose in Block S120. Generally, in Block S120, the system 100 can maneuver the tire interface assembly 120 to locate a wheel disc of the wheel assembly substantially parallel (e.g., within approximately ten degrees of the plane approximation of the wheel face) and concentric with a driver window 124 defined in the enclosure 122 and within a field of view of an internal optical sensor 152 arranged within the enclosure 122.

In one implementation, following gross positioning of the tire interface assembly 120 proximal the wheel assembly, the controller can: access an image captured by the external optical sensor 150 arranged on the enclosure 122 and depicting the wheel assembly mounted to the vehicle; and generate a plane approximation of the wheel disc of the wheel assembly based on the image. In particular, the controller can: extract a set of visual features from the image; generate a point cloud representation of the wheel assembly based on the set of visual features; and implement plane derivation techniques (e.g., plane fitting, plane equations, least squares) to derive a plane approximation of a wheel face of the wheel disc of the wheel assembly based on the point cloud representation.

In one implementation, the controller can derive a target pose for the tire interface assembly 120 based on the plane approximation. In particular, the controller can derive the target pose specifying: a target lateral position and a target vertical position that locate the driver window 124 substantially concentric with the wheel disc of the wheel assembly; and a target pitch angle that locates the driver 130 substantially orthogonal to the wheel disc of the wheel assembly.

The controller can then trigger the set of actuators 160 to locate the tire interface assembly 120 in the target pose. For example, the controller can: trigger a linear track, arranged adjacent the vehicle, to navigate the tire interface assembly 120 along the side of the vehicle to the target lateral position; trigger an elevator, elevator interposed between the tire interface assembly 120 and the linear track, to maneuver the tire interface assembly 120 to the target vertical position; and trigger a pitch actuator to maneuver the tire interface assembly 120 to the target pitch angle.

In one example, the controller can derive a target pose that defines a fine position (e.g., X, Y, Z position) of the tire interface assembly 120 proximal left-front wheel assembly and an orientation (e.g., pitch, yaw) for facing the enclosure 122 of the tire interface assembly 120 proximal the left-front wheel assembly. In this example, the fine position can define: a target lateral position about the periphery of the vehicle lift corresponding to a center of the wheel face; a target longitudinal position (e.g., 0.6 feet) from the center of the wheel face; and a target vertical position from a ground reference of the vehicle lift corresponding to the center of the wheel face. Additionally, the orientation can define: a yaw rotation about a yaw axis of the tire interface assembly 120; and a pitch rotation about a pitch axis of the tire interface assembly 120 to locate the outer facet of the enclosure 122 substantially parallel with the plane approximation of the wheel face.

In this example, the controller can then: trigger a longitudinal actuator to locate the tire interface assembly 120 at the target lateral position corresponding to the center of the wheel face; trigger a latitudinal actuator to locate the tire interface assembly 120 at the target longitudinal position from the center of the wheel face; and trigger an elevator to locate the tire interface assembly 120 at the target vertical position from the ground reference corresponding to the center of the wheel face. Furthermore, the controller can: trigger the yaw actuator to rotate the tire interface assembly 120 about the yaw axis according to the yaw rotation; and trigger the pitch actuator to rotate the tire interface assembly 120 about the pitch axis according to the pitch rotation. Therefore, the controller can accurately and repeatably: derive a target pose for the tire interface assembly 120 proximal a wheel assembly mounted to the vehicle; and trigger the set of actuators 160 to locate the tire interface assembly 120 at the target pose.

### 6.1 Wheel Assembly Engagement+Retention

Block S130 of the method S100 recites triggering a set of end effectors 140, arranged on the enclosure 122 about the driver window 124, to engage a tread of the wheel assembly to transiently retain the wheel assembly. Generally, in Block S130, the controller can trigger the set of end effectors 140 to transition from an open position to a closed position to transiently retain (e.g., grip) the wheel assembly. In particular, the system 100 can transiently retain the wheel assembly during removal and/or installation of lug fasteners to prevent rotation of the wheel assembly.

In one example, the controller can: access a vehicle specification corresponding to the vehicle (e.g., input by an operator); and extract a wheel diameter of the wheel assembly from the vehicle specification. The controller can then: trigger the set of end effectors 140 to actuate to a particular diameter to define a clearance greater than the wheel diameter of the wheel assembly; trigger the set of actuators 160 to drive the set of end effectors 140—in the open position—toward the wheel assembly; and trigger the set of end effectors 140 into a closed position to transiently retain to the wheel assembly.

### 6.2 Lug Fastener Detection

Blocks of the method S100 recite: accessing an image captured by the internal optical sensor 152 and depicting the wheel disc of the wheel assembly in Block S124; detecting a lateral position and a vertical position of a lug fastener, securing the wheel assembly to a wheel hub of the vehicle, based on the image in Block S142; and triggering the multi-axis driver actuator 132 to maneuver the driver 130 across the driver window 124 to align the driver 130 to the lateral position and the vertical position of the lug fastener in Block S150.

In one implementation, the controller can: trigger the multi-axis driver actuator 132 to navigate the driver 130 offset from the driver window 124 to clear a line of sight between the internal optical sensor 152 and the driver window 124; trigger the internal optical sensor 152 to capture an image depicting the wheel disc of the wheel assembly; and detect a set of lug fasteners, securing the wheel assembly to the wheel hub of the vehicle, based on the image. In particular, the controller can: detect a lug fastener depicted in a particular region of the image; and detect a lateral position and a vertical position of the lug fastener based on the image. The controller can then trigger the multi-axis driver actuator 132 to maneuver the driver 130 across the driver window 124 to align the driver 130 to the lateral position and the vertical position of the lug fastener.

### 6.3 Lug Fastener Removal

Blocks of the method S100 recite: triggering the multi-axis driver actuator 132 to drive the driver 130 through the driver window 124 to engage a lug fastener in Block S150; applying a breakaway torque to the lug fastener, via the driver 130, to loosen the lug fastener from a threaded lug stud of the wheel hub in Block S160; triggering the multi-axis driver actuator 132 to maneuver the lug fastener, retained by the driver 130, to a lug holder 126 arranged within the enclosure 122 in Block S152; and trigger the lug holder 126 to transiently retain the lug fastener in Block S162.

In one implementation, the controller can implement methods and techniques described above to: detect a position of a lug fastener of a wheel assembly mounted to the vehicle; and maneuver the driver 130 across the driver window 124 to align the driver 130 to the position of the lug fastener. The controller can then: trigger the multi-axis driver actuator 132 to drive the driver 130 through the driver window 124 to engage the lug fastener; and trigger the driver 130 to apply a breakaway torque to the lug fastener to loosen the lug fastener from a threaded lug stud of the wheel hub. The controller can then: trigger the multi-axis driver actuator 132 to maneuver the lug fastener, retained by the driver 130, to a lug holder 126 arranged within the enclosure 122; and trigger the lug holder 126 to transiently retain the lug fastener. The system 100 can then repeat this process to: remove the set of lug fasteners from the wheel assembly; and store these removed lug fasteners at the set of lug holders 126 arranged within the enclosure 122. In particular, by stowing these removed lug fasteners within the enclosure 122, the system 100 can rapidly retrieve these lug fasteners during installation of a new wheel assembly at the wheel hub.

### 6.3.1 Variation: Lug Fastener Removal Pattern

In one variation, the controller can: access a vehicle specification corresponding to the vehicle; extract a particular socket size of a socket for removing a set of lug fasteners of the wheel assembly from the vehicle specification; extract a torque tightening limit (e.g., 90 Newton-meters) the set of lug fasteners from the vehicle specification; and extract a lug fastener pattern (e.g., star pattern, crisscross) for removing and tightening lug fasteners from the wheel assembly from the vehicle specification.

The controller can then, in response to a socket size of the driver 130 corresponding to the particular socket size (e.g., 13/16 inch) in the vehicle specification: trigger the multi-axis driver actuator 132 to navigate the driver 130 (e.g., impact driver 130) through the driver window 124 toward the position of the lug fastener on the wheel face; and trigger the driver 130 to apply a breakaway torque (e.g., greater than the torque tightening limit) to loosen the lug fastener from a corresponding lug stud at the wheel disc. Alternatively, in response to the socket size deviating from the particular socket size in the vehicle specification, the controller can: prompt an operator to replace a socket of the driver 130 to the particular socket size; and/or trigger the tire interface assembly 120 to autonomously replace a socket of the driver 130 to the particular socket size. The system 100 can then repeat this process according to the lug fastener pattern to loosen the set of lug fasteners arranged on the wheel face of the wheel disc. For example, the system 100 can: extract a star pattern corresponding to five lug fasteners arranged on the wheel face of the wheel disc; and repeat steps described above according to the star pattern to remove and stow the five lug fasteners from the wheel face of the left wheel assembly.

Following loosening of the set of lug fasteners, the controller can: trigger the multi-axis driver actuator 132 to navigate the driver 130 (e.g., impact driver 130) to the position of a loosened lug fastener on the wheel face; trigger the driver 130 to transiently retain the lug fastener; and trigger the multi-axis driver actuator 132 to locate the lug fastener at a lug holder 126 arranged within the enclosure 122 of the tire interface assembly 120.

### 6.4 Lug Type Detection

In one implementation, the system 100 can implement similar methods and techniques described in U.S. Provisional Application No. 63/896,606, filed on 9 Oct. 2025, which is incorporated in its entirety by this reference, to detect presence of a lug nut or a lug bolt in the socket as the driver 130 retracts the socket into the enclosure in preparation for storing contents of the driver 130 (i.e., a lug nut or lug bolt) inside of the enclosure 122. In particular, lug nuts and lug bolts may be visually indistinguishable when installed on a wheel hub and wheel assembly, and the system 100 can execute identical lug removal cycles to remove both lug nuts and lug bolts from a wheel hub and wheel assembly. However, lug nuts and lug bolts may require internal and external retention, respectively.

Therefore, after executing a lug removal cycle to remove a lug fastener from a wheel hub and wheel assembly of a vehicle, the system 100 can: withdraw the socket into the enclosure, thereby sweeping the socket past the internal optical sensor; capture an image (e.g., a 2D or 3D color image; a 2D line image; a 1D or 2D depth image) of the socket; scan this image for presence of a threaded section extending from the distal end of the socket; and either flag the lug fastener occupying the socket as a lug bolt in response to detecting this threaded section or flag this lug fastener as a lug nut in response to detecting absence of this threaded section. The system 100 can then: configure a lug holder 126 within the enclosure 122 to receive this lug fastener (e.g., by triggering the lug holder 126 to open and then close onto the external threaded section of the lug fastener if a lug bolt; by triggering the lug holder 126 to close and then open into the internal threaded section of the lug fastener if a lug nut); and/or assign this lug fastener to a particular lug holder 126 within the enclosure 122 based on the type of the lug fastener.

Therefore, the system 100 can leverage an image of the socket—following a lug removal cycle—to identify a type of fastener socket occupying the socket and to configure or assign a lug holder 126 to retain this lug fastener without prior knowledge of a make and model of the vehicle or a type of lug fastener implemented on the vehicle.

### 6.5 Wheel Assembly Storage

Blocks of the method S100 recite: retracting the wheel assembly, retained by the set of end effectors 140, away from the vehicle in Block S122; and maneuvering the wheel assembly to a staging position in Block S112. Generally, in Block S112, following removal of the set of lug fasteners from the wheel assembly, the system 100 can maneuver the wheel assembly, retained by the set of end effectors 140, from the wheel hub to a staging position (e.g., on the tire cart 180, on the ground surface of the work zone).

### 6.5.1 Variation: Staging Zone

In one variation, Blocks of the method S100 recite: navigating to a staging zone located on a ground surface within the work zone in Block S112; pivoting the tire interface assembly 120 to locate the staging zone within a field of view of an external optical sensor 150 arranged on the enclosure 122 in Block S114; maneuvering the tire interface assembly 120 to locate the wheel assembly proximal a target staging position in Block S170; and triggering the set of end effectors 140 to release the wheel assembly in Block S132.

In one variation, following removal of the set of lug fasteners from the wheel assembly, the controller can trigger the set of actuators 160 to: maneuver the tire interface assembly 120 to a staging zone located on a ground surface within the work zone; and pivot the tire interface assembly 120 to locate the staging zone within the field of view of the external optical sensor 150 arranged on the enclosure 122. The controller can then: access an image captured by the external optical sensor 150 and depicting unoccupied staging positions located on the ground surface; and derive a target staging position, within the staging zone, for storing the wheel assembly based on the image. The controller can then: trigger the set of actuators 160 to maneuver the tire interface assembly 120 to locate the wheel assembly proximal the target staging position; and trigger the set of end effectors 140 to release the wheel assembly. Thus, in this variation, the tire interface assembly 120 can pivot (e.g., 90°) to locate the ground surface within the field of view of the external optical sensor 150 and unoccupied ground positions within the staging zone to accurately position and release the removed wheel assembly.

### 6.5.2 Variation: Storage Trolley

In one variation, Blocks of the method S100 recite: navigating to a storage trolley 170 configured to laterally traverse a ground surface within the work zone to transfer wheel assemblies between sides of the vehicle in Block S112; pivoting the tire interface assembly 120 to locate the storage trolley 170 within a field of view of an external optical sensor 150 arranged on the enclosure 122 in Block S114; maneuvering the tire interface assembly 120 to locate the wheel assembly on the storage trolley 170 in Block S170; and maneuvering the storage trolley 170, transiently storing the wheel assembly, along the ground surface from a first side of the vehicle to a second side of the vehicle opposite the first side.

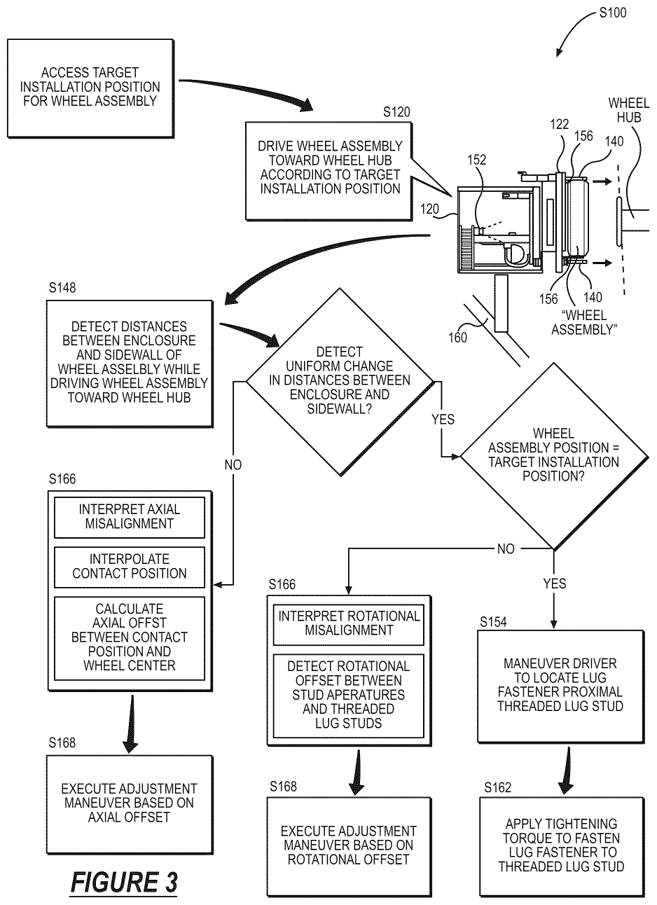

In one variation, as shown in FIGS. 1C and 3, following removal of the set of lug fasteners from the wheel assembly, the controller can trigger the set of actuators 160 to: maneuver the tire interface assembly 120 to proximal a storage trolley 170 configured to laterally traverse a ground surface within the work zone to transfer wheel assemblies between sides of the vehicle; and pivot the tire interface assembly 120 to locate the storage trolley 170 within the field of view of the external optical sensor 150. The controller can then: access an image captured by the external optical sensor 150 and depicting unoccupied wheel slots on the storage trolley 170; maneuver the tire interface assembly 120 to locate the wheel assembly in an unoccupied wheel seat on the storage trolley 170; and trigger the set of end effectors 140 to release the wheel assembly to locate the wheel assembly on the storage trolley 170. The controller can then trigger the trolley actuator of the storage trolley 170 to transfer the storage trolley 170 from proximal a first side of the vehicle to proximal a second side of the vehicle.

### 6.5.3 Variation: Tire Cart

In one variation, as shown in FIGS. 6A and 6B, following removal of the set of lug fasteners from the wheel assembly, the controller can: trigger the set of actuators 160 to navigate the wheel assembly, retained by the set of end effectors 140, toward a first side of the tire cart 180; and trigger the set of end effectors 140 into the open position to release the wheel assembly to locate the wheel assembly in a first slot located on the first side of the storage rack.

In one example, the controller can: trigger a left set of actuators 160 to navigate a left-front wheel assembly, retained by the set of end effectors 140, toward the first side of the tire cart 180; and trigger the set of end effectors 140 into the open position to release the left-front wheel assembly to locate the left-front wheel assembly in a first slot located on the first side of the storage rack. The controller can then similarly and concurrently: trigger the right set of actuators 160 to maneuver a right-rear wheel assembly, retained by the set of end effectors 140, toward the second side of the storage rack; and trigger the set of end effectors 140 into the open position to release the right-rear wheel assembly to locate the right-rear wheel assembly in a second slot located on the second side of the storage rack.

In this example, following loading of the wheel assemblies onto the tire cart 180, the controller can trigger the set of cart actuators 182 to rotate the tire cart 180 (e.g., 180 degrees) to: locate the left-front wheel assembly proximal the right tire interface assembly 120; and locate the right-rear wheel assembly proximal the left tire interface assembly 120. Thus, in this example, the system 100 can interchange wheel assemblies between a left side and a right side of the vehicle without manual intervention to lift and maneuver wheel assemblies proximal the vehicle.

### 7. Wheel Assembly Installation

Generally, the system 100 can execute a wheel installation cycle to: retrieve a wheel assembly via the tire interface assembly 120; maneuver the wheel assembly to the wheel hub; and install a set of lug fasteners at a wheel disc of the wheel assembly to secure the wheel assembly to the wheel hub.

### 7.1 Wheel Assembly Retrieval

Blocks of the method S100 recite: navigating the tire interface assembly 120 along the work zone to locate the enclosure 122 of the tire interface assembly 120 proximal a wheel assembly (e.g., stored on a ground surface within the work zone) in Block S112; pivoting the tire interface assembly 120 to locate the wheel assembly within a field of view of the external optical sensor 150 arranged on the enclosure 122 in Block S114; triggering the set of end effectors 140 to engage a tread of the wheel assembly to transiently retain the wheel assembly in Block S130; pivoting the tire interface assembly 120 to lift the wheel assembly from the ground surface in Block S116; and maneuvering the wheel assembly, retained by the set of end effectors 140, to proximal the wheel hub of the vehicle in Block S110.

In one implementation, the controller can: trigger the set of actuators 160 to navigate the interface assembly to a wheel assembly located at a staging position (e.g., on the tire cart 180, on the storage trolley 170, on the ground surface); trigger the set of actuators 160 to pivot the tire interface assembly 120 to locate the wheel assembly within a field of view of the external optical sensor 150 arranged on the enclosure 122; and access an image captured by the external optical sensor 150 and depicting the wheel assembly arranged on the ground surface.

In one implementation, the system 100 can: implement methods and techniques described above to locate a wheel assembly, uninstalled from the vehicle, at a staging position within the staging zone (e.g., on the storage trolley, on the tire cart, or at a ground surface position); and select a new wheel assembly for retrieval from the staging zone.

For example, a wheel assembly can include indicia (e.g., markings, color codes, QR codes) configured to indicate designation of the wheel assembly (e.g., left-front wheel assembly, right-rear wheel assembly). In this example, the controller can: access an image depicting a set of wheel assemblies arranged at the staging zone; detect indicia located on the wheel assembly based on the image; and select the wheel assembly for installation, such as based on the current task queue or vehicle configuration.

In another example, the operator may locate the new target wheel assembly within the staging zone. The controller can then: receive confirmation of the new target wheel assembly for installation from the operator; and implement methods and techniques described below to autonomously retrieve and install the wheel assembly on the vehicle.

The controller can then implement methods and techniques described above to derive a plane approximation of the wheel face of the wheel disc of the wheel assembly. In particular, the controller can derive a target pose for the tire interface assembly 120 that: aligns an outer facet of the enclosure 122 of the tire interface assembly 120 substantially parallel to the plane approximation of the wheel face; positions the driver window 124 (e.g., an aperture) arranged on the enclosure 122 substantially concentric with the wheel face of the wheel disc; and orients the driver 130 (e.g., impact driver 130) substantially orthogonal to the plane approximation of the wheel face.

The controller can then: trigger the set of actuators 160 to maneuver the tire interface assembly 120 to the target pose; and trigger the set of end effectors 140 to engage a tread of the wheel assembly to transiently retain the wheel assembly.

In particular, the controller can trigger the set of end effectors 140 to: actuate to a particular diameter such that the set of end effectors 140 can clear the outer circumference of the wheel assembly (e.g., the tread surface); drive toward the wheel assembly in the open position; and transition from the open position to the closed position to transiently retain (e.g., grip) the wheel assembly. The controller can then: trigger the set of actuators 160 to pivot the tire interface assembly 120 to lift the wheel assembly from the ground surface; and trigger the set of actuators 160 to maneuver the wheel assembly, retained by the set of end effectors 140, to proximal the wheel hub of the vehicle.

In one example, the controller can: trigger a left set of actuators 160 to locate a left tire interface assembly 120 at the target pose; and trigger the set of end effectors 140 to transiently retain a right-rear wheel assembly (e.g., at the tire cart 180). The controller can then trigger the left set of actuators 160 to maneuver the right-rear wheel assembly, via the left tire interface assembly 120, proximal a wheel hub (i.e., the left-front wheel hub) of the vehicle. In this example, the controller can also: trigger a right tire interface assembly 120 to transiently retain the left-front wheel assembly (e.g., at the tire cart 180); and trigger a right set of actuators 160 to maneuver the left-front wheel assembly, via the right tire interface assembly 120, proximal a wheel hub (i.e., the right-rear wheel hub) of the vehicle.

### 7.2 Wheel Assembly Positioning

Blocks of the method S100 recite: accessing an image captured by the external optical sensor 150 and depicting the wheel hub of the vehicle in Block S128; detecting a set of threaded lug studs arranged on the wheel hub in Block S144; maneuvering the tire interface assembly 120 to align a set of stud apertures of the wheel assembly to the set of threaded lug studs arranged on the wheel hub; and driving the wheel assembly toward the wheel hub to seat the wheel assembly on the wheel hub in Block S126. Generally, the system 100 can: detect a set of threaded lug studs arranged on the wheel hub (i.e., protruding from the wheel hub); derive a target pose of the tire interface assembly 120 for seating the wheel assembly on the wheel hub; and drive the wheel assembly toward the wheel hub according to the target pose.

In one implementation, the controller can: access an image captured by the external optical sensor 150 and depicting a set of threaded lug studs arranged at the wheel hub of the vehicle; and detect a set of threaded lug studs protruding from the wheel hub based on the image. As shown in FIG. 6A, the controller can then implement computer vision techniques to, based on the image: derive a stud axis, in a set of stud axes, for each lug stud in the set of threaded lug studs; calculate an average stud axis based on the set of stud axes; and derive a stud plane approximation orthogonal to the set of threaded lug studs. The controller can then derive a target pose of the tire interface assembly 120 that: locates the driver window 124 of the enclosure 122 substantially parallel to the stud plane approximation; locates a driver axis of the driver 130 coaxial with the average stud axis; and locates a set of lug stud apertures on the wheel disc in alignment with the set of threaded lug studs.

In one variation, the system 100 can: access a target installation position for installing the wheel assembly on the wheel hub; drive the wheel assembly toward the target installation position (e.g., via the set of end effectors 140, via the set of actuators 160); and detect distances between the set of depth sensors 156 arranged on the enclosure 122 and a sidewall of the wheel assembly when the set of end effectors 140 drive the wheel assembly toward the target installation position. In response to detecting a uniform change in distances between the set of depth sensors 156 and the sidewall and in response to detecting the wheel assembly located at the target installation position, the system 100 can interpret installation (e.g., correct installation) of the wheel assembly at the wheel hub. Thus, the system 100 can confirm proper alignment and seating of the wheel assembly prior to initiating lug-fastening operations.

### 7.2.1 Stored Target Installation Position

In one variation, Blocks of the method S100 recite, during a first time period: detecting an end effector position of the set of end effectors 140 when the set of end effectors 140 engages a first tread of a first wheel assembly in Block S146; detecting a first set of distances between a set of depth sensors 156 arranged on the enclosure 122 and a first sidewall of the first wheel assembly when the set of end effectors 140 engages the first tread of the first wheel assembly in Block S148; and storing the end effector position and the first set of distances as a target installation position corresponding to the wheel hub in Block S134. In this variation, Blocks of the method S100 also recite, during a second time period: detecting a second set of distances between the set of depth sensors 156 and a second sidewall of a second wheel assembly when the set of end effectors 140 engages a second tread of the second wheel assembly in Block S148; updating the target installation position based on a difference between the first set of distances and the second set of distances in Block S134; and driving the second wheel assembly toward the target installation position via the set of end effectors 140 in Block S126.

In this variation, as shown in FIGS. 2A and 2B, during removal of a first wheel assembly, the controller can: detect an end effector position of the set of end effectors 140 when the set of end effectors 140 engages the first tread of the first wheel assembly; detect a first set of distances between a set of depth sensors 156 (e.g., ultrasonic sensors) arranged on the enclosure 122 and a first sidewall of the first wheel assembly when the set of end effectors 140 engages the first tread of the first wheel assembly; and store the end effector position and the first set of distances as a target installation position corresponding to the wheel hub. The controller can then, during installation of a second wheel assembly: detect a second set of distances between the set of depth sensors 156 and a second sidewall of the second wheel assembly when the set of end effectors 140 engages the second tread of the second wheel assembly; and update the target installation position based on a difference between the first set of distances and the second set of distances. In particular, the controller can update the target installation position to normalize the stored reference to the geometry of the replacement wheel, such as to compensate for dimensional variation between wheel assemblies.

The controller can then trigger the set of end effectors 140 to drive the second wheel assembly toward the target installation position. Accordingly, the system 100 can: store the target installation position corresponding to the wheel hub as a reference for subsequent wheel assembly installation; and leverage the stored target installation position to reinstall a replacement wheel assembly at the same hub position from which the previous wheel assembly was removed.

In another variation, the controller can: implement methods and techniques described above to generate a first plane approximation of a first wheel disc of the first wheel assembly based on an image captured by the external optical sensor 150; store the first plane approximation as a coarse geometric reference for subsequent wheel assembly installation; and overwrite the first plane approximation with a reference wheel installation position derived from the end effector position and distances detected by the set of depth sensors 156.

In particular, the controller can: detect an end effector position of the set of end effectors 140 when the set of end effectors 140 engages the first tread of the first wheel assembly; detect a first set of distances between the set of depth sensors 156 and the first sidewall of the first wheel assembly when the set of end effectors 140 engages the first tread of the first wheel assembly; and generate a reference wheel installation position of the first wheel disc based on the end effector position and the first set of distances. The controller can then: trigger the set of actuators 160 to locate the tire interface assembly 120 proximal a second wheel assembly (e.g., located in a staging zone); trigger the set of end effectors 140 to engage a second tread of the second wheel assembly to transiently retain the second wheel assembly; trigger the set of actuators 160 to maneuver the second wheel assembly, retained by the set of end effectors 140, to proximal the wheel hub of the vehicle; and trigger the set of actuators 160 to drive the second wheel assembly toward the wheel hub based on the reference wheel installation position. Accordingly, the system 100 can overwrite the plane approximation derived from the external optical sensor 150 with the reference wheel installation position derived from depth sensor 156 data to increase alignment accuracy during a subsequent wheel assembly installation at the wheel hub.

### 7.3 Installation Error: Axial Misalignment

In one variation, Blocks of the method S100 recite: detecting distances between the enclosure 122 and a sidewall of a wheel assembly while driving the wheel assembly toward a target installation position corresponding to the wheel hub in Block S148; in response to detecting a nonuniform change in distances between the enclosure 122 and the sidewall of the wheel assembly, calculating an axial offset distance between a contact position, corresponding to contact between the wheel hub and the second wheel disc, and a center of the wheel disc in Block S166; and maneuvering the wheel assembly, based on the axial offset distance, to align the center of the wheel disc to a center of the wheel hub in Block S168.

In this variation, as shown in FIG. 3, the system 100 can: access a target installation position for installing a wheel assembly on a wheel hub; drive the wheel assembly toward the target installation position; and detect distances between the set of depth sensors 156 arranged on the enclosure 122 and a sidewall of the wheel assembly while driving the wheel assembly toward the target installation position. In response to detecting a nonuniform change in distances between the set of depth sensors 156 and the sidewall, the system 100 can: interpret an axial misalignment between a wheel disc of the wheel assembly and the wheel hub; and derive an adjustment maneuver for execution by the set of actuators 160 to locate the wheel assembly substantially concentric with the wheel hub. In particular, the system 100 can: interpolate a contact position of the wheel hub on the wheel disc based on distances between the set of depth sensors 156 and the sidewall of the wheel assembly; calculate an offset distance between the contact position and a center of the wheel disc; and maneuver the wheel assembly based on the offset distance to align the center of the wheel disc to a center of the wheel hub.

In one example, the set of end effectors 140 includes a set of three end effectors 140 including: a pair of upper end effectors 140 arranged on the enclosure 122 and located above the driver window 124; and a lower end effector arranged on the enclosure 122 and located below the driver window 124. In this example, during removal of a first wheel assembly at the wheel hub, the controller can: detect an end effector position of the set of end effectors 140 and a set of distances between a set of depth sensors 156 arranged on the enclosure 122 and a first sidewall of the first wheel assembly (e.g., 44 mm, 44 mm, and 44 mm at the first upper, second upper, and lower end effectors 140, respectively); and store the end effector position and the set of distances as a target installation position corresponding to the wheel hub.

Then, while driving a second wheel assembly toward the target installation position, the controller can: detect a first distance of 42 mm between a first upper end effector (e.g., a first roller-gripper) and a first region of the sidewall of the second wheel assembly; detect a second distance of 45 mm between a second upper end effector and a second region of the sidewall of the second wheel assembly, laterally offset from the first region by approximately 120 mm; and detect a third distance of 43 mm between the lower end effector and a lower region of the sidewall of the second wheel assembly, vertically offset from the first and second regions by approximately 180 mm.

The controller can then: interpolate a contact plane of the wheel assembly based on the three detected distances, wherein a 3 mm variance in the upper-end-effector distances indicates an angular deviation of approximately 2.0° from the stored reference wheel installation position corresponding to the wheel hub; and trigger the set of actuators 160 to laterally maneuver the tire interface assembly 120 by 4 mm and vertically maneuver the tire interface assembly 120 by 2 mm to realign the contact plane of the wheel assembly with the stored reference wheel installation position of the wheel hub.

The controller can then: trigger the set of actuators 160 to drive the second wheel assembly toward the wheel hub; and, in response to detecting a uniform change in distances between the set of depth sensors 156 and the sidewall and in response to detecting the second wheel assembly located at the target installation position, interpret installation (e.g., correct installation) of the second wheel assembly at the wheel hub. Thus, the system 100 can interpret deviations in depth-sensor distance uniformity as axial misalignment and automatically reposition the wheel assembly to align the wheel assembly to the wheel hub.

### 7.4 Installation Error: Rotational Misalignment

In one variation, Blocks of the method S100 recite: detecting distances between the enclosure 122 and a sidewall of a wheel assembly while driving the wheel assembly toward a target installation position corresponding to the wheel hub in Block S148; in response to detecting a uniform change in distances between the enclosure 122 and the sidewall of the second wheel assembly and in response to a position of the wheel assembly deviating from the target installation position, calculating a rotational offset between the set of stud apertures and the set of threaded lug studs in Block S166; and maneuvering the wheel assembly, based on the rotational offset, to align the set of stud apertures to the set of threaded lug studs in Block S168.

In one variation, as shown in FIG. 3, the system 100 can: access a target installation position for installing a wheel assembly on a wheel hub; drive the wheel assembly toward the target installation position; and detect distances between the set of depth sensors 156 arranged on the enclosure 122 and a sidewall of the wheel assembly while driving the wheel assembly toward the target installation position. In response to detecting a uniform change in distances between the set of depth sensors 156 and the sidewall and in response to detecting a position of the wheel assembly deviating from the target installation position, the system 100 can interpret a rotational misalignment between a set of stud apertures of the wheel assembly and a set of threaded lug studs arranged on the wheel hub.

The system 100 can then: access a first image captured by the internal optical sensor 152 and depicting the set of stud apertures of the wheel assembly; access a second image depicting the set of threaded lug studs arranged on the wheel hub, such as an image captured while retracting the set of end effectors, retaining a previously-removed wheel assembly, from the wheel hub; calculate a rotational offset between the set of stud apertures and the set of threaded lug studs based on the first image and the second image; and maneuver the wheel assembly based on the rotational offset to align the set of stud apertures to the set of threaded lug studs.

For example, in the preceding example, while driving a second wheel assembly toward the target installation position, the controller can detect a uniform change in distances of 42 mm, 42 mm, and 42 mm between the set of depth sensors 156 and corresponding regions of the sidewall (i.e., indicating that the wheel assembly is axially aligned with the stored reference wheel installation position but not rotationally seated on the wheel hub).

The controller can then: access a first image depicting the stud apertures of the wheel assembly and a second image depicting the threaded lug studs of the wheel hub; derive a rotational offset of approximately 6° based on the images; and trigger the set of actuators 160 to rotate the tire interface assembly 120 by 6° to align the stud apertures with the threaded lug studs. Thus, the system 100 can interpret uniform distance changes in addition to angular deviation as rotational misalignment and automatically reposition the wheel assembly to align the wheel assembly to the wheel hub.

### 7.5 Lug Fastener Installation

Blocks of the method S100 recite: triggering the lug holder 126 to release the lug fastener in Block S160; triggering the multi-axis driver actuator 132 to maneuver the lug fastener, retained by the driver 130, to the threaded lug stud protruding through a stud aperture of the wheel assembly in Block S154; and applying a tightening torque to the lug fastener, via the driver 130, to fasten the lug fastener to the threaded lug stud in Block S162. Generally, the system 100 can: detect positions of a set of threaded lug studs arranged on the wheel hub (i.e., protruding from the wheel hub); retrieve lug fasteners, stored at lug holders 126 within the enclosure 122, via the driver 130; and install lug fasteners at threaded lug studs, arranged on the wheel hub, to install the wheel assembly to the wheel hub.

In one implementation, the controller can: trigger the multi-axis driver actuator 132 to navigate the driver 130 offset from the driver window 124 to clear a line of sight between the internal optical sensor 152 and the driver window 124; access a window-view image captured by the internal optical sensor 152; detect a threaded lug stud protruding from a lug aperture of the wheel face of the wheel disc based on the image; and detect a position of the threaded lug stud extending from the wheel disc. In particular, the controller can: access an image captured by the internal optical sensor 152 and depicting the wheel assembly retained by the set of end effectors 140; and detect a lateral position and a vertical position of a threaded lug stud, in a set of threaded lug studs arranged on the wheel hub, based on the image.

The controller can then: trigger the multi-axis driver actuator 132 to maneuver the driver 130 to a lug holder 126, arranged within the enclosure 122, storing a lug fastener; and trigger the lug holder 126 to release the lug fastener. The controller can then: trigger the multi-axis driver actuator 132 to maneuver the lug fastener, retained by the driver 130, to the lateral position and the vertical position of the threaded lug stud protruding through a stud aperture of the wheel assembly; and trigger the driver 130 to apply a tightening torque to the lug fastener to fasten the lug fastener to the threaded lug stud.

### 7.5.1 Fastening Pattern+Torque Limits

In one variation, the controller can: trigger the multi-axis driver actuator 132 to maneuver the driver 130 (e.g., impact driver 130) proximal the lug holder 126 at the enclosure 122; trigger the driver 130 to transiently retain a lug fastener at the lug holder 126; trigger the multi-axis driver actuator 132 to maneuver the lug fastener, via the driver 130, at the position of the threaded lug stud extending from the wheel disc; and trigger the driver 130 to apply a pre-torque (or “snug torque”) to seat the lug fastener at the threaded lug stud extending from the wheel face. The system 100 can then repeat this process across a set of threaded lug studs protruding from lug apertures of the wheel face of the wheel disc according to the fastening pattern (e.g., star pattern, crisscross pattern), as described above.

Accordingly, following application of the pre-torque across the set of lug fasteners arranged at lug studs of the wheel hub extending from the wheel face of the wheel disc, the controller can: access a set of torque values output by a moment sensor coupled to the driver 130; trigger the multi-axis driver actuator 132 to maneuver the driver 130 to the position of the lug fastener pre-torqued onto the threaded lug stud; trigger the driver 130 to apply a tightening torque to the lug fastener about the threaded lug stud; and, in response to the set of torque values exceeding the torque tightening limit (e.g., 90 Newton-meters), trigger the driver 130 to terminate application of the torque. The system 100 can then repeat this process across the set of lug fastener pre-torqued (or “seated”) at the set of threaded lug studs of the wheel hub according to the fastening pattern. Following application of the torque tightening limit, the controller can trigger the set of end effectors 140 into the open position to release retention to the wheel assembly of the wheel assembly and thus, finalize installation of the wheel assembly at the wheel hub of the vehicle. Therefore, the system 100 can accurately and repeatably install a set of lug fasteners at a set of threaded lug studs protruding from at a wheel face of the wheel disc according to a target fastening pattern and a torque tightening limit.

### 8. Interference+Wheel Slip Detection

In one variation, Blocks of the method S100 recite: triggering the set of end effectors 140 to actuate to a first diameter and drive toward the wheel assembly at the first diameter in Block S130; detecting forces exerted on the set of end effectors 140 when driving the set of end effectors 140 toward the wheel assembly in Block S180; interpreting interference between the set of end effectors 140 and a structure of the vehicle surrounding the wheel assembly in Block S182; and triggering the set of end effectors 140 to actuate to a second diameter less than the first diameter and drive toward the first wheel assembly at the second diameter in Block S184.

In particular, in this variation, the tire interface assembly 120 includes a force sensor 154 (e.g., a load cell) arranged proximal the set of end effectors 140 and configured to detect forces exerted on the set of end effectors 140, such as during approach and retraction of the set of end effectors 140 and/or during retention of a wheel assembly at the tire interface assembly 120.

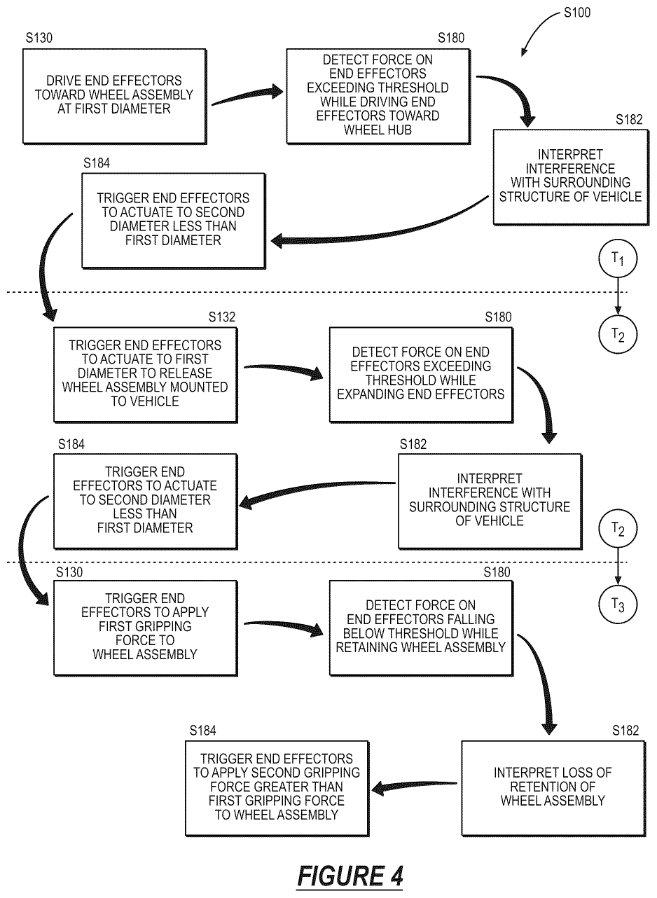

In this variation, as shown in FIG. 4, prior to removal of a wheel assembly from the vehicle, the controller can trigger the set of end effectors 140 to: actuate to a first diameter, such as a particular diameter that enables the set of end effectors 140 to clear the outer circumference of the wheel assembly (e.g., the tread surface); and drive toward the wheel assembly at the first diameter. The controller can then: access signals output by the force sensor when driving the set of end effectors 140 toward the wheel assembly; detect forces exerted on the set of end effectors 140 based on these signals; and, in response to a first force exceeding a threshold force and in response to a position of the set of end effectors 140 located forward of a sidewall of the wheel assembly, interpret interference between the set of end effectors 140 and a structure of the vehicle surrounding the wheel assembly.

In particular, the controller can interpret this force as interference when the set of end effectors 140 is positioned within the fender region, not yet in contact with the tire, and force readings are detected on end effectors 140 not engaged with a wheel assembly. In response to interpreting interference between the set of end effectors 140 and the structure of the vehicle, the controller can trigger the set of end effectors 140 to: actuate to a second diameter less than the first diameter; and drive toward the first wheel assembly at the second diameter. Thus, the system 100 can interpret early force feedback at positions forward of the wheel sidewall as fender interference during approach and automatically reduce end-effector span to prevent collision damage to the tire interface assembly 120 and the vehicle.

In another variation, following installation of a wheel assembly onto the vehicle, the controller can trigger the set of end effectors 140 to retract away from the wheel assembly at the first diameter. The controller can then: detect forces exerted on the set of end effectors 140 when retracting the set of end effectors 140 away from the wheel assembly; and, in response to a force exceeding the threshold force and in response to a position of the set of end effectors 140 located past the sidewall of the wheel assembly, interpret interference between the set of end effectors 140 and the structure of the vehicle surrounding the wheel assembly. In particular, the controller can interpret this force as interference when the set of end effectors 140 register load after the wheel sidewall has cleared the hub but remains within the fender region, indicating contact with the surrounding structure rather than the tire.

In response to interpreting interference between the set of end effectors 140 and the structure of the vehicle, the controller can trigger the set of end effectors 140 to: actuate to the second diameter (i.e., less than the first diameter); and retract away from the wheel assembly at the second diameter. Thus, the system 100 can interpret force readings occurring past the wheel sidewall as fender interference during retraction and automatically contract the end effector span to prevent collision or surface damage to the fender.

In another variation, during removal of a wheel assembly from the vehicle, the controller can trigger the set of end effectors 140 to apply a first gripping force to the wheel assembly to retain the wheel assembly at the tire interface assembly 120. The controller can then: detect forces exerted on the wheel assembly by the set of end effectors 140 when retaining the wheel assembly at the tire interface assembly 120; and, in response to a force falling below a threshold range characteristic of nominal wheel assembly retention, interpret loss of retention of the wheel assembly by the set of end effectors 140. In response to interpreting loss of retention of the wheel assembly by the set of end effectors 140, the controller can trigger the set of end effectors 140 to apply a second gripping force, greater than the first gripping force, to the wheel assembly. Thus, the system 100 can interpret a drop in measured gripping force as loss of tire retention and automatically increase end-effector force to maintain secure engagement during wheel removal.

### 9. Variation: Non-Directional Tire Rotation

In one variation, the system 100 can execute a non-directional wheel rotation cycle to autonomously rearrange non-directional wheel assemblies mounted on a vehicle (e.g., a two-axle vehicle, a cargo vehicle) in a crisscross pattern. For example, the system 100 can: interchange the left-front wheel assembly with the right-rear wheel assembly of the vehicle; and interchange the left-rear wheel assembly with the right-front wheel assembly of the vehicle. Although the following implementation describes controls for executing a non-directional wheel rotation cycle on a vehicle (e.g., a two-axle vehicle, a cargo vehicle), the steps described above can be implemented for vehicles of more than two axles (e.g., buses, RVs, trailers).

In this variation, the system 100 can the implement methods and techniques described above to concurrently install/un-install wheel assemblies from a left side and a right side of the vehicle. Following installation of the left-front wheel assembly to the right-rear hub of the vehicle and installation of the right-rear wheel assembly to the left-front wheel hub of the vehicle, the system 100 can then implement methods and techniques described above to: install the left-rear wheel assembly at the right-front wheel hub of the vehicle; and install the right-front wheel assembly at the left-rear wheel hub of the vehicle.

In another variation, the system 100 can: generate a prompt requesting confirmation of successful non-directional tire rotation on the vehicle by the operator; serve this prompt to the operator; and, in response to receiving confirmation of a successful non-directional tire rotation, trigger the vehicle lift to lower the vehicle.

### 10. Variation: Directional Tire Rotation

In one variation, the system 100 can execute a non-directional wheel rotation cycle to autonomously rearrange directional wheel assemblies mounted on a left and right side of a vehicle (e.g., a two-axle vehicle, a cargo vehicle). More specifically, the system 100 can implement methods and techniques described above to: interchange a left-front wheel assembly with a left-rear wheel assembly of the vehicle; and interchange a right-front wheel assembly with a right-rear wheel assembly of the vehicle. For example, rather than triggering handoff of the tire cart 180 from a left side to a right side of the vehicle, the system 100 can: un-install the left-front wheel assembly from a left-front wheel hub of the vehicle; load the left-front wheel assembly at the tire cart 180; un-install the left-rear wheel assembly from the left-rear wheel hub of the vehicle; and load the left-rear wheel assembly at the tire cart 180. The system 100 can then implement methods and techniques described above to: install the left-front wheel assembly at the left-rear wheel hub of the vehicle; and install the left-rear wheel assembly at the left-front wheel hub of the vehicle. Furthermore, the system 100 can repeat this process for the wheel assemblies arranged at the right side of the vehicle.

### 11. Variation: Tire Replacement

In one variation, the system 100 can execute a new wheel assembly installation cycle to autonomously install new wheel assemblies on a left and/or a right side of a vehicle (e.g., a two-axle vehicle, a cargo vehicle). For example, an operator may: load a set of new wheel assemblies onto the tire cart 180; and maneuver the tire cart 180 proximal the vehicle lift and/or couple the tire cart 180 to the cart actuator 182. Accordingly, rather than interchanging wheel assemblies arranged on the vehicle, the system 100 can implement methods and techniques described above to autonomously: un-install a wheel assembly from the vehicle; stow the un-installed wheel assembly at the tire cart 180; retrieve a new wheel assembly from the tire cart 180; and install the new wheel assembly at the vehicle. Therefore, the system 100 can accurately and repeatably install new wheel assemblies on a vehicle without requiring manual intervention to lift and maneuver new wheel assemblies proximal the vehicle.

### 12. Variation: Lug Fastener Installation Errors

In one variation, the controller can detect fastener installation errors, such as broken/damaged lug studs and/or cross-threading, based on a sequence of torque values read from the torque sensor coupled to the driver 130 (e.g., during installation of a lug fastener). In one example, the controller can: derive a target quantity of rotations to couple a lug fastener to the threaded lug stud at a target torque tightening specification; and during application of the driver 130 to the threaded lug stud, detect (e.g., track) a quantity of rotations via an encoder coupled to the driver 130. The controller can then, in response to the quantity of rotations exceeding the target quantity of rotations, interpret an installation error (e.g., a broken and/or damaged lug stud).

Additionally or alternatively, the controller can, in response to detecting torque values exceeding the torque tightening specification limit prior to completion of the target quantity of rotations, interpret an installation error, such as cross-threading between the lug fastener and the threaded lug stud, a broken and/or damaged lug fastener, or a broken and/or damaged lug stud.

Additionally or alternatively, the controller can: detect application of a null-torque (e.g., zero torque output) based on the sequence of torque values; and interpret this application of null-torque as an installation error, such as a broken and/or damaged lug fastener.

For example, the controller can: detect an installation error during installation of the wheel assembly to the vehicle; generate a prompt to an operator specifying the installation error and requesting the operator to resolve this installation error; and serve this prompt to the operator, such as to a mobile device associated with the operator and/or a computer system proximal the vehicle lift.

### 13. Variation: Guided Transition for Tire Cart

In one variation, as shown in FIGS. 9A and 9B, the system 100 includes: a mounting platform 190 coupled to the tire cart 180 receptacle; and a pivoting caster assembly 192 coupled to the tire cart 180 and configured to transiently couple to the mounting platform 190 and transition between a mobile position and a mounting position. In this variation, during mounting of the tire cart 180 onto the mounting platform 190 (e.g., via an operator), the pivoting caster assembly 192: mechanically guides alignment of the tire cart 180 relative to the mounting platform 190; and supports the weight of the tire cart 180 throughout mounting, such as to reduce physical strain experienced by the operator.

### 13.1 Mounting Platform

In one variation, the tire cart 180 receptacle includes: a linear actuator configured to mount to a ground surface and to translate the tire cart 180 receptacle along a linear path (e.g., parallel to a vehicle lift); a rotary actuator (e.g., a rotary bearing assembly) coupled to the linear actuator and configured to rotate the tire cart 180 receptacle about a vertical axis orthogonal to the linear path; and a mounting platform 190 (e.g., a rectangular platform) coupled to the rotary actuator. The mounting platform 190: includes an engagement channel defined along opposing lateral sides of the mounting platform 190 and configured to transiently receive and support a set of rollers (e.g., alignment rollers, support rollers) of instances of the pivoting caster assembly 192 at the tire cart 180; defines a geometry complementary to a geometry of the base of the tire cart 180 to mechanically constrain lateral alignment between the tire cart 180 and the mounting platform 190 and align the set of rollers with the engagement channel; and is configured to transiently locate and retain the tire cart 180 during translation and rotation of the tire cart 180 receptacle.

Therefore, rather than integrating actuators into the tire cart 180, the system 100 can localize linear and rotary actuators at the tire cart 180 receptacle to: reduce mechanical complexity and weight of the tire cart 180; and simplify mechanical alignment and loading of the tire cart 180 onto the tire cart 180 receptacle.

### 13.2 Pivoting Caster Assembly

In one variation, the pivoting caster assembly 192 includes a caster base (e.g., pivotable mounting bracket): configured to pivot about a pitch axis; and operable in a mobile position (e.g., oriented downward for rolling) and a mounting position (e.g., rotated approximately 90 degrees for receptacle engagement). In this variation, the pivoting caster assembly 192 further includes a caster wheel (e.g., locking caster) coupled to the caster base. More specifically, the pivoting caster assembly 192: defines a pitch axis oriented horizontally and orthogonally relative to a rolling axis of the caster wheel; and pivots the caster base about the pitch axis to transition the caster wheel between the mobile position (e.g., rolling axis substantially parallel to a ground plane to enable mobility) and the mounting position (e.g., rolling axis substantially perpendicular to the ground plane to mechanically interface with the mounting platform 190).

For example, the caster base can include: a primary portion (e.g., mounting bracket, fixed support) configured to rigidly mount to the base of the tire cart 180; and a secondary portion pivotably coupled to the primary portion about a pitch axis defined by a pivot shaft and/or hinge assembly. In this example, the caster wheel: includes a wheel hub rotatably coupled to the secondary portion about a rolling axis; and defines a rolling axis orthogonal to the pitch axis, such that pivoting the secondary portion about the pitch axis transitions orientation of the caster wheel between the mobile position (e.g., the rolling axis parallel to a ground plane) and the mounting position (e.g., the rolling axis perpendicular to the ground plane).

Additionally, the caster base includes: an alignment roller configured to transiently insert into the engagement channel of the mounting platform 190 to mechanically constrain vertical alignment of the tire cart 180 relative to the mounting platform 190; and a support roller configured to interface with an upper surface of the platform to support the tire cart 180 when retained by the mounting platform 190. During mounting of the tire cart 180 onto the mounting platform 190, the engagement channel of the mounting platform 190 mechanically interfaces with the alignment roller of the pivoting caster assembly 192 to angularly displace the caster base from the mobile position into the mounting position. During removal of the tire cart 180 from the mounting platform 190, the engagement channel of the mounting platform 190 mechanically interfaces with the alignment roller of the pivoting caster assembly 192 to angularly displace the caster base from the mounting position into the mobile position.

Furthermore, the pivoting caster assembly 192 also includes a locking mechanism (e.g., mechanical latch integrated into handles of the tire cart 180) configured to selectively: lock the caster base in the mobile position (e.g., caster wheel oriented toward the ground plane) to support movement of the tire cart 180 by an operator; and release the caster base into a mounting configuration (e.g., caster wheel rotated approximately 90 degrees from the mobile position) to align and mount the tire cart 180 onto the mounting platform 190 of the tire cart 180 receptacle.

Accordingly, the tire cart 180 can include instances of the pivoting caster assembly 192, such as arranged at four corners of the tire cart 180, to form a reconfigurable cart that reduces operator effort during mounting of the tire cart 180 to the tire cart 180 receptacle.

### 13.3 Mounting Tire Cart to Mounting Platform

In one variation, prior to initialization of a tire installation cycle, the controller can trigger the linear and rotary actuators of the tire cart 180 receptacle to translate and rotate the mounting platform 190 (e.g., oriented and aligned to mechanically interface with the tire cart 180) to receive the tire cart 180. For example, the controller can trigger the linear and rotary actuators to translate and rotate the mounting platform 190 into a loading configuration proximal a loading area (e.g., adjacent a ramp, an alignment track), such that an operator can directly maneuver the tire cart 180 onto the mounting platform 190 with reduced alignment effort.

The system 100 can then: generate a prompt indicating that the tire cart 180 receptacle is located in the loading configuration and requesting the operator to mount the tire cart 180 onto the mounting base; and serve this prompt (e.g., via a local operator interface, visual indicator, audible notification) to an operator device (e.g., tablet) associated with the operator. The operator can then: maneuver the tire cart 180 proximal the loading area of the tire cart 180 receptacle; align the pivoting caster assemblies of the tire cart 180 with corresponding engagement channels defined along lateral sides of the mounting platform 190; unlock instances of the pivoting caster assemblies to transition the tire cart 180 from a mobile position into a mounting position; and apply a forward-directed force to mechanically engage the pivoting caster assemblies within the engagement channels.

As the operator mounts the tire cart 180 onto the mounting platform 190, the tire cart 180: engages support rollers of the pivoting caster assemblies with upper surfaces of opposing lateral sides of the mounting platform 190 to vertically support and guide the tire cart 180; and translates alignment rollers within corresponding engagement channels of the mounting platform 190 to mechanically constrain lateral alignment of the tire cart 180 relative to the mounting platform 190. During translation of the alignment roller within the engagement channel, instances of the pivoting caster assembly 192 at the tire cart 180: rotate from the straight configuration (e.g., caster wheels aligned parallel to a longitudinal axis of the tire cart 180) into the rotated configuration (e.g., caster wheels oriented approximately 90 degrees relative to the straight configuration); and maintain mechanical clearance between the tire cart 180 and actuators of the tire cart 180 receptacle throughout mounting and subsequent operation of the tire cart 180 receptacle.

The system 100 can then: confirm successful mounting of the tire cart 180, such as by detecting a threshold force (e.g., weight of the tire cart 180) via sensors integrated into the tire cart 180 receptacle; and initiate the tire installation cycle in response to detecting the threshold force indicating successful mounting of the tire cart 180.

### 14. Mobile Tire Storage

Generally, the system 100 can implement automated inventory management techniques (e.g., First-In-First-Out (FIFO), Last-In-First-Out (LIFO), Just-In-Time (JIT) inventory) to manage storage and retrieval of wheel-tire assemblies in preparation for executing a wheel installation cycle at a vehicle lift.

### 14.1 Wheel Assembly Retrieval+New Wheel-tire Assembly Inventory

In one variation, the system 100 can: access an inventory list representing wheel-tire assemblies (e.g., tire make, tire model, load rating) currently available for installation at a particular maintenance zone; access a vehicle specification corresponding to a particular vehicle scheduled for maintenance at the maintenance zone; and define a wheel-tire assembly manifest specifying a set of new wheel-tire assemblies required for installation based on the vehicle specification. For example, the system 100 can define the wheel-tire assembly manifest by matching tire specifications (e.g., tire size, load rating, speed rating, manufacturer recommendations) from the inventory list to tire requirements indicated by the vehicle specification. The system 100 can then: generate a prompt requesting an operator to retrieve the set of wheel-tire assemblies defined by the wheel-tire assembly manifest and load these assemblies onto a tire cart 180; and serve the prompt and the wheel-tire assembly manifest (e.g., via a local display interface or operator terminal) to the operator.

In one example, the system 100 further includes an optical scanner (e.g., barcode scanner, QR-code scanner), such as integrated into the tire cart 180 or a handheld device for the operator, configured to read identifiers (e.g., QR codes, barcodes, serial numbers) corresponding to wheel-tire assemblies loaded onto the tire cart 180 by the operator. In this example, following loading of wheel-tire assemblies at the tire cart 180, the system 100 can: access scan data from the optical scanner; extract identifiers (e.g., tire make, model, serial number) corresponding to the wheel-tire assemblies loaded onto the tire cart 180; confirm successful loading of these wheel-tire assemblies in response to these extracted identifiers matching identifiers specified in the wheel-tire assembly manifest; update the inventory list to reflect availability of wheel-tire assemblies based on these extracted identifiers; and generate and serve a prompt instructing the operator to maneuver the tire cart 180 containing these confirmed wheel-tire assemblies to the tire cart 180 receptacle.

Therefore, the system 100 can: maintain an accurate inventory representation of wheel-tire assemblies currently available for installation based on real-time scanning of wheel-tire assemblies; generate and serve notifications prompting operators to initiate procurement of additional wheel-tire assemblies in response to inventory quantities falling below a defined threshold; and verify compatibility of loaded wheel-tire assemblies with a currently scheduled vehicle prior to initiating a wheel-tire assembly installation cycle.

### 14.2 Pre-Loaded Tire Cart

In one variation, the system 100 can: access a cart inventory log representing tire carts 180 pre-loaded with wheel-tire assemblies, such as previously loaded by an operator as described above, or loaded by a robotic loading system; access a vehicle specification corresponding to a currently scheduled vehicle; define a wheel-tire assembly manifest specifying wheel-tire assemblies required for installation based on the vehicle specification; and identify a particular tire cart 180 in the cart inventory log containing wheel-tire assemblies corresponding to identifiers specified in the wheel-tire assembly manifest. The system 100 can then: identify a location of the particular tire cart 180 within the maintenance zone, such as based on positional data (e.g., localization data from positioning sensors integrated into the tire cart 180) and a digital map representing spatial features of the maintenance zone; generate a prompt requesting the operator to retrieve this particular tire cart 180 from the tire cart 180 location and mount the tire cart 180 at the tire cart 180 receptacle; and serve the prompt and the tire cart 180 location (e.g., as coordinates or visual representation) to the operator.

Thus, rather than prompting an operator to manually retrieve and load individual wheel-tire assemblies onto a tire cart 180, the system 100 can generate and serve a prompt instructing the operator to retrieve a pre-loaded tire cart 180 containing wheel-tire assemblies previously confirmed as compatible with a currently scheduled vehicle, prior to initiating a wheel-tire assembly installation cycle.

### 14.3 Pre-Loading Schedule

In one variation, the system 100 can access a maintenance schedule representing vehicles scheduled for wheel-tire assembly installation (e.g., daily maintenance schedule, weekly maintenance schedule) by the system 100. As described above, for each vehicle represented in the maintenance schedule, the system 100 can then: define a wheel-tire assembly manifest specifying wheel-tire assemblies required for installation based on a corresponding vehicle specification; identify a location of an available tire cart 180 within the maintenance zone; generate a prompt for retrieving and loading of wheel-tire assemblies specified by the wheel-tire assembly manifest onto this available tire cart 180; and serve the wheel-tire assembly manifest, tire cart 180 location, and prompt (e.g., via a local operator interface) to the operator and/or a robotic loading system. Additionally, the system 100 can further prompt the operator to maneuver the loaded tire cart 180 to a staging zone (e.g., a designated holding area within the maintenance zone), where the tire cart 180 is temporarily retained until the system 100 subsequently prompts an operator to retrieve the tire cart 180 in preparation for a wheel-tire assembly installation cycle.

Thus, the system 100 can routinely (e.g., daily, weekly) generate and serve prompts instructing operators and/or a robotic loading system to load tire carts 180 with wheel-tire assemblies based on vehicle maintenance schedules, thereby maintaining a fleet of pre-loaded tire carts 180 within a staging zone in preparation for scheduled wheel-tire assembly installation cycles.

### 15. Disclaimer

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other system and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A method comprising:
navigating a tire interface assembly along a work zone proximal a vehicle to locate the tire interface assembly proximal a first wheel assembly mounted to the vehicle;
maneuvering the tire interface assembly to locate a first wheel disc of the first wheel assembly:
substantially parallel to and concentric with a driver window defined in an enclosure of the tire interface assembly; and
within a first field of view of an internal optical sensor arranged within an enclosure of the tire interface assembly;
engaging a first tread of the first wheel assembly via a set of end effectors, arranged on the enclosure about the driver window, to transiently couple the first wheel assembly to the tire interface assembly;
accessing a first image captured by the internal optical sensor and depicting the first wheel disc of the first wheel assembly;
detecting a first lateral position and a first vertical position of a first lug fastener, securing the first wheel assembly to a wheel hub of the vehicle, based on the first image;
via a multi-axis driver actuator arranged within the enclosure:
maneuvering a driver, arranged within the enclosure, across the driver window to align the driver to the first lateral position and the first vertical position of the first lug fastener; and
extending the driver through the driver window to engage the first lug fastener;
applying a breakaway torque to the first lug fastener to loosen the first lug fastener on a first threaded lug stud of the wheel hub;
via the multi-axis driver actuator:
retracting the driver, retaining the first lug fastener, through the driver window and into the enclosure; and
maneuvering the driver to align the first lug fastener to a first lug holder arranged within the enclosure; and
via the first lug holder, retaining the first lug fastener.

2. The method of claim 1, further comprising:
maneuvering a second wheel assembly, retained by the set of end
effectors, to proximal the wheel hub of the vehicle;
maneuvering the tire interface assembly to locate the wheel hub of the vehicle within a second field of view of an external optical sensor arranged on the enclosure;
detecting a set of threaded lug studs arranged on the wheel hub based on a second image captured by the external optical sensor;
driving the second wheel assembly, retained by the set of end effectors, toward the wheel hub to seat the set of threaded lug studs within a set of stud apertures of the second wheel assembly;
via the driver, engaging the first lug fastener retained in the first lug holder;
via the first lug holder, releasing the first lug fastener;
via the multi-axis driver actuator, maneuvering the first lug fastener, retained by the driver, to the first threaded lug stud protruding through a first stud aperture of the second wheel assembly; and
via the driver, applying a tightening torque to the first lug fastener to fasten the first lug fastener to the first threaded lug stud.

3. The method of claim 1, further comprising:
during a first time period:
in response to the set of end effectors engaging the first tread of the first wheel assembly:
detecting an end effector position of the set of end effectors; and
detecting a first set of distances between a reference plane on the enclosure and a first sidewall of the first wheel assembly via a set of distance sensors arranged on the enclosure; and
calculating a reference wheel installation position for the wheel hub based on a combination of the end effector position and the first set of distances; and
during a second time period:
engaging a second tread of a second wheel assembly, located in a staging zone, via the set of end effectors to transiently couple the second wheel assembly to the tire interface assembly;
in response to the set of end effectors engaging the second tread of the second wheel assembly, detecting a second set of distances between the reference plane on the enclosure and a second sidewall of the second wheel assembly via the set of distance sensors;
calculating a target end effector position for installation of the second wheel assembly on the wheel hub based on a combination of the reference wheel installation position and the second set of distances; and
maneuvering the tire interface assembly to drive the set of end effectors, retaining the second wheel assembly, toward the target end effector position to locate the second wheel assembly proximal the wheel hub.

4. The method of claim 3, further comprising:
while maneuvering the tire interface assembly to drive the set of end effectors, retaining the second wheel assembly, toward the target end effector position:
in response to detecting nonuniform changes in distances between the reference plane on the enclosure and the second sidewall of the second wheel assembly based on signals output by the set of distance sensors:
detecting an axial misalignment between a second wheel disc of the second wheel assembly and the wheel hub;
interpolating a contact position of contact between the wheel hub and the second wheel disc based on nonuniform changes in distances between the reference plane on the enclosure and the second sidewall of the second wheel assembly;
calculating an axial offset distance between the contact position and a center of the second wheel disc; and
maneuvering the set of end effectors, retaining the second wheel assembly, by the axial offset distance, to align the center of the second wheel disc to the center of the wheel hub.

5. The method of claim 3, further comprising:
while maneuvering the tire interface assembly to drive the set of end effectors, retaining the second wheel assembly, toward the target end effector position:
in response to detecting uniform reduction in distances between the reference plane on the enclosure and the second sidewall of the second wheel assembly, based on signals output by the set of distance sensors, prior to the set of end effectors occupying the target end effector position for installation of the second wheel assembly on the wheel hub:
detecting a rotational misalignment between a second wheel disc of the second wheel assembly and the wheel hub; and
in response to detecting the rotational misalignment between the second wheel disc and the wheel hub:
retracting the set of end effectors, retaining the second wheel assembly, from the wheel hub;
rotating the set of end effectors to reduce the rotational misalignment between the second wheel disc and the wheel hub; and
driving the set of end effectors toward the target end effector position to locate the second wheel assembly on the wheel hub.

6. The method of claim 5, further comprising:
retracting the set of end effectors, retaining the first wheel assembly, from the wheel hub;
accessing a second image captured by the internal optical sensor and depicting the wheel hub while retracting the set of end effectors, retaining the first wheel assembly, from the wheel hub;
detecting a first set of positions of a set of threaded lug studs arranged on the wheel hub based on the second image;
accessing a third image captured by the internal optical sensor and
depicting a second wheel disc of the second wheel assembly while engaging the second tread of the second wheel assembly via the set of end effectors;
detecting a second set of positions of a set of stud apertures arranged on the second wheel disc based on the third image; and
rotating the set of end effectors to rotationally align the second set of positions of the set of stud apertures to the first set of positions of the set of threaded lug studs.

7. The method of claim 3, further comprising, while maneuvering the tire interface assembly to drive the set of end effectors, retaining the second wheel assembly, toward the target end effector position:
in response to detecting uniform reduction in distances between the reference plane on the enclosure and the second sidewall of the second wheel assembly, based on signals output by the set of distance sensors and in response to the set of end effectors occupying the target end effector position for installation of the second wheel assembly on the wheel hub:
interpreting installation of the second wheel assembly in the reference wheel installation position;
via the multi-axis driver actuator, maneuvering the driver to the first lug holder retaining the first lug fastener;
via the driver, engaging the first lug fastener retained in the first lug holder;
via the first lug holder, releasing the first lug fastener;
accessing a second image captured by the internal optical sensor and depicting a second wheel disc of the second wheel assembly seated on the wheel hub;
detecting a first position of the first threaded lug stud, protruding through a first stud aperture of the second wheel assembly, based on the second image;
via the multi-axis driver actuator:
maneuvering the driver across the driver window to align the driver to the first position of the first threaded lug stud; and
extending the driver through the driver window to seat the first lug fastener on the first threaded lug stud; and
applying a tightening torque to the first lug fastener to fasten the first lug fastener to the first threaded lug stud.

8. The method of claim 1:
further comprising:
accessing a second image captured by an external optical sensor arranged on the enclosure and defining a second field of view external to the enclosure;
detecting the first wheel assembly mounted to the vehicle based on the second image;
defining a target gross position to locate the tire interface assembly proximal the first wheel assembly based on the second image;
calculating a plane approximation of the first wheel disc of the first wheel assembly based on the second image; and
storing the plane approximation as a reference installation plane corresponding to the wheel hub;
wherein navigating the tire interface assembly along the work zone comprises navigating the tire interface assembly along the work zone to locate the tire interface assembly in the target gross position; and
wherein maneuvering the tire interface assembly to locate the first wheel disc substantially parallel and concentric with the driver window and within the first field of view of the internal optical sensor comprises:
during a first time period, maneuvering the tire interface assembly to:
locate an axis of the driver window normal to the plane approximation of the first wheel disc; and
locate the wheel hub in the first field of view of the internal optical sensor, the first field of view intersecting the driver window; and
during a second time period succeeding the first time period:
maneuvering the tire interface assembly along the axis of the driver window toward the wheel hub to locate the set of end effectors in contact with the first wheel assembly.

9. The method of claim 8, further comprising:
during a third time period succeeding the second time period:
in response to distal ends of the set of end effectors crossing the plane approximation of the first wheel assembly:
contracting the set of end effectors to engage the first tread of the first wheel assembly; and
during a fourth time period:
while maneuvering the tire interface assembly along the axis of the driver window toward the wheel hub:
detecting a first set of distances between a reference plane of the enclosure and a first sidewall of the first wheel assembly based on signals output by a set of distance sensors arranged on the enclosure;
rotating the enclosure orthogonal to the axis of the driver window to reduce differences between distances in the first set of distances; and
in response to the first set of distances approximating a target offset distance, halting motion of the tire interface assembly along the axis of the driver window.

10. The method of claim 1, further comprising:
retracting the first wheel assembly, retained by the set of end effectors, from the vehicle;
navigating to a staging zone located on a ground surface within the work zone;
pivoting the tire interface assembly to locate the staging zone within a second field of view of an external optical sensor arranged on the enclosure;
accessing a second image captured by the external optical sensor while the tire interface assembly pivots to locate the staging zone within the
second field of view of the external optical sensor;
detecting a target staging position, within the staging zone, for storing the first wheel assembly based on the second image;
maneuvering the tire interface assembly to locate the first wheel assembly within the target staging position;
via the set of end effectors, releasing the first wheel assembly in the target staging position;
detecting a second wheel disc of a second wheel assembly located in the staging zone based on the second image;
maneuvering the tire interface assembly to locate the second wheel disc of the second wheel assembly substantially parallel to and concentric with the driver window;
via the set of end effectors, engaging a second tread of the second wheel assembly to transiently couple the second wheel assembly to the tire interface assembly; and
maneuvering the second wheel assembly, retained by the set of end effectors, to proximal the wheel hub of the vehicle.

11. The method of claim 1:
wherein navigating the tire interface assembly to the first wheel assembly comprises navigating the tire interface assembly to the first wheel assembly located on a left side of the vehicle; and
further comprising:
retracting the set of end effectors, retaining the first wheel assembly, from the wheel hub;
navigating the tire interface assembly to a storage trolley, transiently located proximal the left side of the vehicle, configured to laterally traverse a ground surface within the work zone to transfer wheel assemblies between sides of the vehicle;
via a rotational actuator, pivoting the tire interface assembly to locate the storage trolley within a second field of view of an external optical sensor arranged on the enclosure;
accessing a second image captured by the external optical sensor while the tire interface assembly pivots to locate the storage trolley within the second field of view of the external optical sensor;
detecting a target staging position, on the storage trolley, for storing the first wheel assembly based on the second image;
maneuvering the tire interface assembly to locate the first wheel assembly in the target staging position;
via the set of end effectors, releasing the first wheel assembly in the target staging position; and
via a trolley actuator, maneuvering the storage trolley, transiently storing the first wheel assembly, along the ground surface from proximal the left side of the vehicle to proximal a right side of the vehicle.

12. The method of claim 11, further comprising:
navigating a second tire interface assembly along a second work zone proximal the right side of the vehicle to locate the second tire interface assembly proximal the first wheel assembly stored on the storage trolley;
via a second rotational actuator, pivoting the second tire interface assembly to locate the first wheel disc of the first wheel assembly substantially parallel and concentric with a second driver window defined in a second enclosure of the second tire interface assembly;
engaging the first tread of the first wheel assembly via a second set of end effectors, arranged on the second enclosure about the second driver window, to transiently couple the first wheel assembly to the second tire interface assembly;
maneuvering the first wheel assembly, retained by the second set of end effectors, to proximal a second wheel hub located on the right side of the vehicle;
maneuvering the second tire interface assembly to locate the second wheel hub of the vehicle within the second field of view of the external optical sensor;
detecting a set of threaded lug studs arranged on the second wheel hub based on a third image captured by the external optical sensor;
driving the first wheel assembly, retained by the second set of end effectors, toward the second wheel hub to seat the set of threaded lug studs within a set of stud apertures of the first wheel assembly;
via a second driver arranged within the second enclosure, engaging a second lug fastener retained in a second lug holder arranged within the second enclosure;
via the second lug holder, releasing the second lug fastener;
via a second multi-axis driver actuator arranged within the second enclosure, maneuvering the second lug fastener, retained by the second driver, to a second threaded lug stud protruding through a stud aperture of the first wheel assembly; and
via the second driver, applying a tightening torque to the second lug fastener to fasten the second lug fastener to the second threaded lug stud.

13. A system comprising:
a tire interface assembly comprising:
an enclosure defining a driver window;
a set of lug holders arranged within the enclosure and configured to store threaded lug fasteners;
a driver:
arranged within the enclosure; and
configured to apply a torque to a lug fastener, in a set of lug fasteners, securing a first wheel assembly to a wheel hub of a vehicle located adjacent the tire interface assembly;
a multi-axis driver actuator configured to:
laterally maneuver the driver across the driver window;
vertically maneuver the driver across the driver window; and
longitudinally maneuver the driver through the driver window;
a set of end effectors:
arranged on the enclosure about the driver window; and
configured to engage a first tread of the first wheel assembly to transiently couple the first wheel assembly to the tire interface assembly;
an external optical sensor:
arranged on the enclosure; and
defining a first field of view external to the enclosure; and
an internal optical sensor:
arranged within the enclosure; and
defining a second field of view intersecting the driver window; and
a set of actuators configured to:
maneuver the tire interface assembly along the vehicle to locate the driver window proximal a first wheel disc of the first wheel assembly; and
pivot the tire interface assembly to:
locate the driver window substantially parallel and concentric with the first wheel disc; and
locate a driver axis of the driver substantially orthogonal to the first wheel disc.

14. The system of claim 13:
wherein the set of lug holders comprises:
a multi-jaw chuck comprising a set of jaws operable in:
a closed position; and
an open position;
wherein, during a first time period:
the multi-jaw chuck is configured to contract the set of jaws to the closed position;
the multi-axis driver actuator is configured to maneuver the driver to locate the lug fastener, transiently retained by the driver, on the set of jaws in the closed position; and
the multi-jaw chuck is configured to expand the set of jaws to the open position to transiently retain internal threads of the lug fastener; and
wherein, during a second time period:
the multi-jaw chuck is configured to expand the set of jaws to the open position;
the multi-axis driver actuator is configured to maneuver the driver to locate a lug bolt, transiently retained by the driver, within the set of jaws in the open position; and
the multi-jaw chuck is configured to contract the set of jaws to the closed position to transiently retain external threads of the lug bolt.

15. The system of claim 13:
wherein the external optical sensor is:
arranged on an exterior of the enclosure; and
configured to capture images depicting positions and orientations of wheel assemblies mounted to the vehicle;
wherein the internal optical sensor is:
arranged within an interior of the enclosure; and
configured to capture images depicting positions of lug fasteners of wheel assemblies retained by the set of end effectors;
further comprising a controller configured to:
access a first image captured by the external optical sensor and depicting the first wheel assembly mounted to the vehicle;
derive a target pose for the tire interface assembly to engage the first wheel assembly based on the first image, the target pose specifying:
a target lateral position and a target vertical position that locate the driver window substantially concentric with the first wheel disc of the first wheel assembly; and
a target pitch angle that locates the driver substantially orthogonal to the first wheel disc of the first wheel assembly;
trigger the set of actuators to locate the tire interface assembly in the target pose;
access a second image captured by the internal optical sensor and depicting the first wheel assembly retained by the set of end effectors; and
detect a lateral position and a vertical position of the lug fastener of the first wheel assembly based on the second image;
wherein the multi-axis driver actuator is configured to:
laterally maneuver the driver across the driver window to the lateral position of the lug fastener;
vertically maneuver the driver across the driver window to the vertical position of the lug fastener; and
longitudinally maneuver the driver through the driver window to engage the lug fastener; and
wherein the driver is configured to apply a breakaway torque to the lug fastener to loosen the lug fastener from a threaded lug stud on the wheel hub.

16. The system of claim 13:
wherein the tire interface assembly further comprises a force sensor:
coupled to the set of end effectors;
interposed between the set of end effectors and the enclosure; and
configured to output signals representing forces exerted on the set of end effectors;
further comprising a controller;
wherein, during a first time period:
the controller is configured to:
access a first image captured by the external optical sensor and depicting the first wheel assembly mounted to the vehicle;
estimate a wheel diameter of the first wheel assembly based on the first image;
detect a center axis of the first wheel disc of the first wheel assembly based on the first image; and
calculate a plane approximation of the first wheel disc of the first wheel assembly based on the first image;
the set of actuators is configured to:
pivot the tire interface assembly to locate the driver window substantially orthogonal to the center axis of the first wheel disc and substantially parallel and concentric with the plane approximation of the first wheel disc;
expand the set of end effectors to a first diameter exceeding the wheel diameter of the first wheel assembly; and
drive the set of end effectors toward the first wheel assembly at the first diameter
the force sensor is configured to output a first signal representing a first force exerted on the set of end effectors while the set of end effectors drives toward the first wheel assembly at the first diameter;
the controller is configured to:
access the first signal output by the force sensor and representing the first force exerted on the set of end effectors; and
in response to the first force exceeding a threshold force when the set of end effectors is located forward of a first sidewall of the first wheel assembly:
interpret interference between the set of end effectors and a structure of the vehicle surrounding the first wheel assembly; and
the set of actuators is configured to:
in response to interference between the set of end effectors and the structure of the vehicle surrounding the first wheel assembly:
retract the set of end effectors from the vehicle;
contract the set of end effectors to a second diameter less than the first diameter; and
drive the set of end effectors toward the first wheel assembly at the second diameter;
wherein, during a second time period:
the set of actuators is configured to:
drive distal ends of the set of end effectors past the plane approximation of the first wheel assembly; and
contract the set of end effectors to engage the first tread of the first wheel assembly to transiently couple the first wheel assembly to the tire interface assembly during removal of the first wheel assembly from the wheel hub of the vehicle; and
wherein, during a third time period:
the set of actuators is configured to:
expand the set of end effectors toward the first diameter to release a second wheel assembly installed at the wheel hub by the tire interface assembly;
the force sensor is configured to output a second signal representing a second force exerted on the set of end effectors while actuating to the first diameter;
the controller is configured to:
access the second signal output by the force sensor and representing the second force exerted on the set of end effectors; and
in response to a second force exceeding the threshold force when the set of end effectors is located past a second sidewall of the second wheel assembly:
interpret interference between the set of end effectors and the structure of the vehicle surrounding the second wheel assembly; and
the set of actuators arise configured to:
in response to interference between the set of end effectors and the structure of the vehicle surrounding the second wheel assembly:
contract the set of end effectors to the second diameter less than the first diameter; and
retract the set of end effectors from the vehicle along to withdraw the set of end effectors from the second wheel assembly.

17. The system of claim 13, wherein the set of end effectors:
comprises:
an upper end effector
configured to contact the first tread of the first wheel assembly proximal an upper region of the first wheel assembly; and
a lower end effector
configured to contact the first tread of the first wheel assembly proximal a lower region of the first wheel assembly; and
operable in:
a first position on the enclosure to transiently retain wheel assemblies exhibiting diameters within a first diameter range; and
a second position on the enclosure to transiently retain wheel assemblies exhibiting diameters within a second diameter range greater than the first diameter range.

18. The system of claim 13:
wherein the tire interface assembly further comprises:
a set of socket holders:
arranged within the enclosure; and
configured to store sockets;
wherein the driver is configured to:
maneuver within the enclosure to retrieve a socket from the set of socket holders;
maneuver through the driver window to seat the socket over the lug fastener;
apply a breakaway torque to the lug fastener to loosen the lug fastener from a threaded lug stud arranged on the wheel hub; and
withdraw the socket, transiently retaining the lug fastener, into the enclosure; and
wherein the multi-axis driver actuator is further configured to maneuver the driver within the enclosure between the driver window, the set of lug holders, and the set of socket holders.

19. The system of claim 13:
further comprising a tire cart:
comprising:
a base; and
a storage rack:
comprising a set of slots configured to transiently store wheel assemblies; and
arranged above and pivotably coupled to the base; and
wherein the tire interface assembly is configured to:
uninstall the first wheel assembly from the wheel hub of the vehicle;
locate the first wheel assembly in a first slot located on a first side of the storage rack;
retrieve a second wheel assembly from a second slot located on a second side, opposite the first side, of the storage rack; and
install the second wheel assembly at the wheel hub.

20. A system comprising:
a tire interface assembly comprising:
an enclosure defining a driver window;
a set of lug holders arranged within the enclosure and configured to store threaded lug fasteners;
a set of end effectors arranged on the enclosure and configured to transiently retain a wheel assembly mounted to a vehicle located adjacent the tire interface assembly;
an internal optical sensor:
arranged within the enclosure; and
configured to capture a first image depicting lug fasteners securing the wheel assembly to a wheel hub of the vehicle;
an external optical sensor:
arranged on the enclosure; and
configured to capture a second image depicting the wheel assembly mounted to the vehicle; and
a driver:
arranged within the enclosure; and
configured to:
maneuver across the driver window to align to a position of a lug fastener depicted in the first image;
maneuver through the driver window to engage the lug fastener;
apply a torque to the lug fastener to remove the lug fastener from a threaded lug stud of the wheel hub of the vehicle; and
maneuver within the enclosure to locate the lug fastener proximal a lug holder in the set of lug holders; and
a set of actuators configured to maneuver the tire interface assembly along the vehicle to:
locate the driver window substantially parallel and concentric with a wheel disc of the wheel assembly depicted in the second image; and
locate a driver axis of the driver substantially orthogonal to the wheel disc of the wheel assembly.
